(19) United States
(12) Patent Application Publication
(10) Pub. No.: US 2018/0010207 A1
(43) Pub. Date: Jan. 11, 2018

(54) HIGH-STRENGTH PLATED STEEL SHEET AND METHOD FOR PRODUCING SAME

(71) Applicant: KABUSHIKI KAISHA KOBE SEIKO SHO (Kobe Steel, Ltd.), Kobe-shi (JP)

(72) Inventors: Yuichi FUTAMURA, Kakogawa-shi (JP); Muneaki IKEDA, Kakogawa-shi (JP); Michiharu NAKAYA, Kakogawa-shi (JP)

(73) Assignee: KABUSHIKI KAISHA KOBE SEIKO SHO (Kobe Steel, Ltd.), Kobe-shi (JP)

(21) Appl. No.: 15/541,862

(22) PCT Filed: Jan. 5, 2016
(86) PCT No.: PCT/JP2016/050068

§ 371 Date: Jul. 6, 2017

(30) Foreign Application Priority Data
Jan. 9, 2015 (JP) 2015-003705
Sep. 15, 2015 (JP) 2015-182115

(51) Int. Cl. C21D 9/46; B32B 15/01; C22C 38/38; C22C 38/16; C22C 38/14; C21D 8/02; C22C 38/08; C22C 38/06; C22C 38/02; C22C 38/00; C23C 2/00; C21D 6/00; C23G 1/08; C22C 38/12

(52) U.S. Cl. CPC C21D 9/46; C23G 1/08; B32B 15/013; C22C 38/38; C22C 38/16; C22C 38/14; C22C 38/12; C22C 38/08; C22C 38/06; C22C 38/02; C22C 38/005; C22C 38/002; C22C 38/001; C23C 2/00; C21D 6/001; C21D 8/0263; C21D 8/0205; C21D 6/008; C21D 6/005; C21D 6/002; C21D 2211/001; C21D 2211/005

(57) ABSTRACT

Disclosed herein is a high-strength plated steel sheet containing an internal oxidized layer, a soft layer including the internal oxidized layer, and a hard layer including a structure having metallic structure containing a low-temperature-transformation produced phase in a proportion of 70% or more by area of the whole of the metallic structure, in which polygonal ferrite is in a proportion of 0% or more by area, and 10% or less by area of the same, and retained austenite is in a proportion of 5% or more by volume of the same. The high-strength plated steel sheet satisfies the average depth D of the soft layer is 20 μm or more, the average depth d of the internal oxidized layer is 4 μm or more and less than D, and a tensile strength of 980 MPa or more.

### TECHNICAL FIELD

The present invention relates to a high-strength plated steel sheet which has a tensile strength of 980 MPa or more and is good in galvanizability and excellent in formabilities, such as elongation, bendability and hole expandability, and in delayed fracture resistance; and a method for producing the high-strength plated steel sheet. The plated steel sheet of the invention includes, in the category thereof, both of a hot-dip galvanized steel sheet, and a hot-dip galvannealed steel sheet.

### BACKGROUND ART

Hot-dip galvanized steel sheets and hot-dip galvanized steel sheets, which are widely used in the field of automobiles, transportation equipment, and others, are required to be made higher in strength, and be excellent in formabilities such as elongation, bendability and hole expandability (equal in meaning to stretch-flanging formability), and in delayed fracture resistance.

In order for a steel to ensure a high strength and formabilities, it is effective to add, into the steel, strengthening elements such as Si and Mn in a large proportion. However, Si and Mn are easily-oxidizable elements. The steel is remarkably deteriorated in wettability for hot-dip galvanizing by, for example, Si oxides, Mn oxides, and composite oxidized films including composite oxides of Si and Mn, which are formed on the surface of the steel sheet, so as to cause bare spots and other problems. Thus, various techniques are suggested for heightening plated steel sheets including Si and Mn in a large proportion in formabilities and others without generating any bare spot.

For example, Patent Literature 1 discloses a hot-dip galvanized steel sheet which has a tensile strength of 590 MPa or more and is excellent in bendability and corrosion resistance of its worked portion. In detail, according to Patent Literature 1, in order to make it possible to restrain a steel sheet from being bent or cracked by its internal oxidized layer formed from an interface of the steel sheet and its galvanized layer or galvannealed layer toward the steel sheet side of the hot-dip galvanized steel sheet, the growth of a decarbonized layer is made remarkably speedy relatively to the growth of the internal oxidized layer. Furthermore, the literature discloses near-surface structure controlled to reduce the thickness of the internal oxidized layer in a ferrite region formed by decarbonization.

Patent Literature 2 discloses a hot-dip galvanized steel sheet which has a tensile strength of 770 MPa or more and is excellent in fatigue resistance, hydrogen embrittlement resistance (equal in meaning to delayed fracture resistance), and bendability. In detail, according to Patent Literature 2, its steel sheet portion is made into a structure having a soft layer directly contacting an interface between the portion and a galvanized layer, and a soft layer including ferrite as a structure having a maximum proportion by area. Furthermore, Patent Literature 2 discloses a hot-dip galvanized steel sheet satisfying d/4≦D≦2d wherein D represents the thickness of the soft layer and d represents the depth of an oxide from the interface between the galvanizing and the substrate iron, this oxide including one or more of Si and Mn present in a surface portion of the steel sheet.

### CITATION LIST

### Patent Literatures

Patent Literature 1: JP 2011-231367 A

Patent Literature 2: Japanese Patent No. 4943558

### SUMMARY OF INVENTION

### Problems to be Solved by the Invention

As described above, various suggestions have been hitherto made about the technique of improving plated steel sheets including Si and Mn in a large proportion in formabilities and others. However, it is desired to provide a technique satisfying various properties required for the plated steel sheets, that is, all of a high strength of 980 MPa or more, good galvanizability, excellent formabilities, such as elongation, bendability and hole expandability, and delayed fracture resistance.

In the light of the situation, the present invention has been made, and an object thereof is to provide a hot-dip galvanized steel sheet and a hot-dip galvanized steel sheet which have a tensile strength of 980 MP or more, and are good in galvanizability and excellent in formabilities such as elongation, bendability and hole expandability, and delayed fracture resistance. Another object of the present invention is to provide a method for producing the hot-dip galvanized steel sheet and the hot-dip galvanized steel sheet.

### Means for Solving the Problems

The high-strength plated steel sheet according to the present invention, which has a tensile strength of 980 MPa or more and can solve the above-mentioned problems, is a high-strength plated steel sheet having a hot-dip galvanized layer or a hot-dip galvannealed layer on a surface of a base steel sheet. This base steel sheet contains, in % by mass: C: 0.10 to 0.5%, Si: 1 to 3%, Mn: 1.5 to 8%, Al: 0.005 to 3%, P: more than 0% to 0.1% or less, S: more than 0% to 0.05% or less, and N: more than 0% to 0.01% or less, the balance being iron and inevitable impurities. The plated steel sheet sequentially comprises, from an interface between the base steel sheet and the galvanized layer or galvannealed layer toward the base steel sheet. An internal oxidized layer comprises at least an oxide selected from the group consisting of Si and Mn. A soft layer comprises the internal oxidized layer, and has a Vickers hardness of 90% or less of a Vickers hardness of a portion of t/4 of the base steel sheet where “t” is a sheet thickness of the base steel sheet. A hard layer consists of a structure having metallic structure which comprises, when the metallic structure is observed through a scanning electron microscope (SEM), a low-temperature-transformation produced phase in a proportion of 70% or more by area of the whole of the metallic structure, and polygonal ferrite in a proportion of 0% to 10% by area of the whole of the metallic structure. The metallic structure further comprises retained austenite (hereinafter referred to as retained γ as the case may be) in a proportion of 5% or more by volume of the whole of the metallic structure when the metallic structure is measured by a saturation magnetization method. The high-strength plated steel sheet satisfies that the average depth D of the soft layer is 20 μm or more, and the average depth d of the internal oxidized layer is 4 μm or more and less than D. This plated steel sheet has the requirements described in this paragraph as a subject matter of the present invention.

It is preferred that the average depth d of the internal oxidized layer and the average depth D of the soft layer satisfy the relationship: D>2d.

It is allowable that the low-temperature-transformation produced phase comprises a high-temperature-range produced bainite in which the average interval between adjacent grains of the retained austenite, between adjacent grains of any carbide or between adjacent grains of the retained austenite and the carbide is 1 μm or more; the proportion of the high-temperature-range produced bainite is more than 50% by area and 95% or less by area of the whole of the metallic structure; the low-temperature-transformation produced phase may comprise low-temperature-range produced bainite in which the average interval between adjacent grains of the retained austenite, between adjacent grains of any carbide or between adjacent grains of the retained austenite and the carbide is less than 1 μm, and may comprise tempered martensite; and the proportion of the total of the low-temperature-range produced bainite and the tempered martensite is 0% or more by area and less than 20% by area of the whole of the metallic structure.

It is allowable that the low-temperature-transformation produced phase comprises a high-temperature-range produced bainite in which the average interval between adjacent grains of the retained austenite, between adjacent grains of any carbide or between adjacent grains of the retained austenite and the carbide is 1 μm or more; a low-temperature-range produced bainite in which the average interval between adjacent grains of the retained austenite, between adjacent grains of any carbide or between adjacent grains of the retained austenite and the carbide is less than 1 μm; and a tempered martensite; the proportion of the high-temperature-range produced bainite is from 20 to 80% by area of the whole of the metallic structure; and the proportion of the total of the low-temperature-range produced bainite and the tempered martensite is from 20 to 80% by area of the whole of the metallic structure.

It is allowable that the low-temperature-transformation produced phase comprises a low-temperature-range produced bainite in which the average interval between adjacent grains of the retained austenite, between adjacent grains of any carbide or between adjacent grains of the retained austenite and the carbide is less than 1 μm, and tempered martensite; the proportion of the total of the low-temperature-range produced bainite and a the tempered martensite is more than 50% by area and 95% or less by area of the whole of the metallic structure; the low-temperature-transformation produced phase may comprise high-temperature-range produced bainite in which the average interval between adjacent grains of the retained austenite, between adjacent grains of any carbide or between adjacent grains of the retained austenite and the carbide is 1 μm or more; and the proportion of the high-temperature-range produced bainite is 0% or more by area and less than 20% by area of the whole of the metallic structure.

The base steel sheet may further comprise, in % by mass, one or more belonging to any one of the following (a) to (d):

(a) one or more selected from the group consisting of Cr: more than 0% to 1% or less, Mo: more than 0% to 1% or less, and B: more than 0% to 0.01% or less;

(b) one or more selected from the group consisting of Ti: more than 0% to 0.2% or less, Nb: more than 0% to 0.2% or less, and V: more than 0% to 0.2% or less;

(c) one or more selected from the group consisting of Cu: more than 0%6 to 1% or less, and Ni: more than 0⁰/a to 1% or less; and

(d) one or more selected from the group consisting of Ca: more than 0% to 0.01% or less, Mg: more than 0% to 0.01% or less, and any rare earth element: more than 0% to 0.01% or less.

The high-strength plated steel sheet can be produced by a producing method comprising, in order: a hot-rolling step of coiling a steel sheet having the steel components of said base steel sheet at a temperature of 600° C. or higher, a step of pickling and cold-rolling the steel sheet such that there remain the internal oxidized layer with an average depth d of 4 μm or more; a step of oxidizing the steel sheet at an air ratio of 0.9 to 1.4 in an oxidizing zone; a step of soaking the steel sheet in a temperature range not lower than the A_{c3} point in a reducing zone; and a step of cooling, after the soaking, the steel sheet to any stopping temperature Z satisfying a temperature from 100 to 540° C., and cooling the steel sheet, in a temperature range from 750° C. to a higher temperature of the stopping temperature Z or 500° C., at an average cooling rate of 10° C./second or more, and retaining the steel sheet in said temperature range of 100 to 540° C. for 50 seconds or longer.

The high-strength plated sheet can also be produced by a producing method comprising, in order: a hot-rolling step of coiling a steel sheet having the steel components of said base steel sheet at a temperature of 500° C. or higher; a step of keeping the temperature of the steel sheet in temperatures of 500° C. or higher for 60 minutes or longer; a step of pickling and cold-rolling the steel sheet such that there remain the internal oxidized layer with an average depth d of 4 μm or more; a step of oxidizing the steel sheet at an air ratio of 0.9 to 1.4 in an oxidizing zone; a step of soaking the steel sheet in a temperature range not lower than the A_{c3} point in a reducing zone; and a step of cooling, after the soaking, the steel sheet to any stopping temperature Z satisfying a temperature from 100 to 540° C., and cooling the steel sheet, in a temperature range from 750° C. to a higher temperature of the stopping temperature Z or 500° C., at an average cooling rate of 10° C./second or more, and retaining the steel sheet in said temperature range of 100 to 540° C. for 50 seconds or longer.

By the following producing method [Ia] or [Ib], the plated steel sheet can be produced in which the low-temperature-transformation produced phase comprises the high-temperature-range produced bainite in a proportion of more than 50% by area and 95% or less by area of the whole of the metallic structure, and the proportion of the total of the low-temperature-range produced bainite and the tempered martensite is 0% or more by area and less than 20% by area of the whole of the metallic structure:

a method [Ia] comprising, in order: a hot-rolling step of coiling a steel sheet having the steel components of said base steel sheet at a temperature of 600° C. or higher; a step of pickling and cold-rolling the steel sheet such that there remain the internal oxidized layer with an average depth d of 4 μm or more; a step of oxidizing the steel sheet at an air ratio of 0.9 to 1.4 in an oxidizing zone; a step of soaking the steel sheet in a temperature range not lower than the A_{c3} point in a reducing zone; and a step of satisfying, after the soaking, a requirement (a1) described below; and

a method [IIa] comprising, in order: a hot-rolling step of coiling a steel sheet having the steel components of said base steel sheet at a temperature of 500° C. or higher, a step of keeping the temperature of the steel sheet in temperatures of 500° C. or higher for 60 minutes or longer; a step of pickling and cold-rolling the steel sheet such that there remain the internal oxidized layer with an average depth d of 4 μm or more; a step of oxidizing the steel sheet at an air ratio of 0.9 to 1.4 in an oxidizing zone; a step of soaking the steel sheet in a temperature range not lower than the A_{c3} point in a reducing zone; and a step of satisfying, after the soaking, the following requirement (a1):

a requirement (a1) of cooling the steel sheet down to any stopping temperature Zₐ₁ satisfying a temperature from 420 to 500° C. both inclusive, and cooling the steel sheet at an average cooling rate of 10° C./second or more in a temperature range from 750° C. to 500° C. and retaining the steel sheet in said temperature range of 420 to 500° C. for 50 seconds or longer.

By the following producing method [IIa] or [IIb], the plated steel sheet can be produced in which the low-temperature-transformation produced phase comprises the high-temperature-range produced bainite in a proportion of 20 to 80% by area of the whole of the metallic structure, and the proportion of the total of the low-temperature-range produced bainite and the tempered martensite is from 20 to 80% by area of the whole of the metallic structure:

a method [IIa] comprising, in order: a hot-rolling step of coiling a steel sheet having the steel components of said base steel sheet at a temperature of 600° C. or higher; a step of pickling and cold-rolling the steel sheet such that there remain the internal oxidized layer with an average depth d of 4 μm or more; a step of oxidizing the steel sheet at an air ratio of 0.9 to 1.4 in an oxidizing zone; a step of soaking the steel sheet in a temperature range not lower than the A_{c3} point in a reducing zone; and a step of satisfying, after the soaking, any one of following requirements (a2), (b) and (c1); and

a method [IIb] comprising, in order: a hot-rolling step of coiling a steel sheet having the steel components of said base steel sheet at a temperature of 500° C. or higher, a step of keeping the temperature of the steel sheet in temperatures of 500° C. or higher for 60 minutes or longer; a step of pickling and cold-rolling the steel sheet such that there remain the internal oxidized layer with an average depth d of 4 μm or more; a step of oxidizing the steel sheet at an air ratio of 0.9 to 1.4 in an oxidizing zone; a step of soaking the steel sheet in a temperature range not lower than the A_{c3} point in a reducing zone; and a step of satisfying, after the soaking, any one of the following requirements (a2), (b) and (c1):

a requirement (a2) of cooling the steel sheet down to any stopping temperature Zₐ₂ satisfying a temperature not lower than 380° C. and lower than 420° C., and cooling the steel sheet at an average cooling rate of 10° C./second or more in a temperature range from 750° C. to 500° C. and retaining the steel sheet in said temperature range not lower than 380° C. and lower than 420° C. for 50 seconds or longer,

a requirement (b) of cooling the steel sheet down to any stopping temperature Z_{b} satisfying an expression (1) described below, and cooling the steel sheet at an average cooling rate of 10° C./second or more in a temperature range from 750° C. to a higher temperature of the stopping temperature Z_{b} or 500° C., retaining the steel sheet in a temperature range T1 satisfying the expression (1) described below for 10 to 100 seconds, next cooling the steel sheet into a temperature range T2 satisfying the following expression (2) and retaining the steel sheet in this temperature range T2 for 50 seconds or longer:

400≦T1(° C.)≦540 (1) and

200≦T2(° C.)<400 (2); and

a requirement (c1) of cooling the steel sheet down to any stopping temperature Z_{c1} satisfying an expression (3) described below or the Ms point, and cooling the steel sheet at an average cooling rate of 10° C./second or more in a temperature range from 750° C. to 500° C., retaining the steel sheet in a temperature range T3 satisfying the expression (3) described below for 5 to 180 seconds, next heating the steel sheet into a temperature range T4 satisfying the following expression (4) and retaining the steel sheet in this temperature range T4 for 30 seconds or longer:

100≦T3(° C.)<400 (3) and

400≦T4(° C.)≦500 (4).

By the following producing method [IIIa] or [IIIb], the plated steel sheet can be produced in which the low-temperature-transformation produced phase comprises the low-temperature-range produced bainite in a proportion of more than 50% by area and 95% or less by area of the whole of the metallic structure, and the proportion of the high-temperature-range produced bainite is 0% or more by area and less than 20% by area of the whole of the metallic structure:

a method [IIIa] comprising, in order: a hot-rolling step of coiling a steel sheet having the steel components of said base steel sheet at a temperature of 600° C. or higher; a step of pickling and cold-rolling the steel sheet such that there remain the internal oxidized layer with an average depth d of 4 μm or more; a step of oxidizing the steel sheet at an air ratio of 0.9 to 1.4 in an oxidizing zone; a step of soaking the steel sheet in a temperature range not lower than the A_{c3} point in a reducing zone; and a step of satisfying, after the soaking, a requirement (a3) or (c2) described below, and

a method [IIIb] comprising, in order: a hot-rolling step of coiling a steel sheet having the steel components of said base steel sheet at a temperature of 500° C. or higher; a step of keeping the temperature of the steel sheet in temperatures of 500° C. or higher for 60 minutes or longer; a step of pickling and cold-rolling the steel sheet such that there remain the internal oxidized layer with an average depth d of 4 μm or more; a step of oxidizing the steel sheet at an air ratio of 0.9 to 1.4 in an oxidizing zone; a step of soaking the steel sheet in a temperature range not lower than the A_{c3} point in a reducing zone; and a step of satisfying, after the soaking, the following requirement (a3) or (c2):

a requirement (a3) of cooling the steel sheet down to any stopping temperature Zₐ₃ satisfying a temperature not lower than 150° C. and lower than 380° C., and cooling the steel sheet at an average cooling rate of 10° C./second or more in a temperature range from 750° C. to 500° C. and retaining the steel sheet in a temperature range not lower than 150° C. and lower than 380° C. for 50 seconds or longer; and

a requirement (c2) of cooling the steel sheet down to any stopping temperature Z_{c2} satisfying an expression (3) described below, or the Ms point, and cooling the steel sheet at an average cooling rate of 10° C./second or more in a temperature range from 750° C. to 500° C., retaining the steel sheet in a temperature range T3 satisfying the expression (3) described below for 5 to 180 seconds, next heating the steel sheet into a temperature range T4 satisfying the following expression (4) and retaining the steel sheet in this temperature range T4 for 30 seconds or longer:

100≦T3(° C.)<400 (3), and

400≦T4(° C.)≦500 (4).

The plated steel sheet is configured to have the following layers from an interface between its galvanized layer or galvannealed layer and base steel sheet to the base steel sheet side of the plated steel sheet: an internal oxidized layer comprising at least one an oxide selected from the group consisting of Si and Mn; a soft layer comprising a region of the internal oxidized layer; and a hard layer that is a region other than the soft layer, is made mainly of a low-temperature-transformation produced phase and includes retained austenite and that may include polygonal ferrite. In particular, the average depth d of the internal oxidized layer is controlled into a value of 4 μm or more to make the layer thick. In this way, the internal oxidized layer is used as hydrogen trapping site to yield a high-strength plated steel sheet which can be effectively restrained from undergoing hydrogen embrittlement, is excellent in all of formabilities such as elongation, bendability and hole expandability, and delayed fracture resistance, and has a tensile strength of 980 MPa or more. Preferably, a relationship between the average depth d of the internal oxidized layer and the average depth D of the soft layer comprising the region of the internal oxidized layer can be appropriately controlled, so that the steel sheet is made even higher, particularly, in bendability

### BRIEF DESCRIPTION OF DRAWINGS

FIG. 1 is a schematic view demonstrating a layer structure from a galvanized layer or galvannealed layer and a base steel sheet of a plated steel sheet of the present invention toward the base steel sheet side of the plate steel sheet.

FIG. 2 is a schematic chart demonstrating steps of measuring the average depth d of an internal oxidized layer in a plated steel sheet of the present invention.

FIG. 3 is a chart demonstrating Vickers-hardness-measuring positions used to determine the average depth D of a soft layer.

FIG. 4 is a schematic view illustrating steps of measuring the between-central-position distance between grains of retained austenite, between grains of any carbide or between grains of the retained austenite and the carbide.

FIGS. 5A and 5B are views that schematically illustrate distribution states of high-temperature-range produced bainite, and low-temperature-range produced bainite and tempered martensite.

FIG. 6 is a schematic chart demonstrating respective heat patterns of a T1 temperature range and a T2 temperature range.

FIG. 7 is a schematic chart demonstrating respective heat patterns of a T3 temperature range and a T4 temperature range.

### DESCRIPTION OF EMBODIMENTS

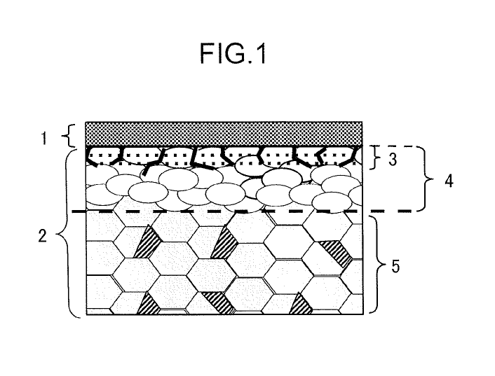

In order to provide a high-strength plated steel sheet in which a base steel sheet including Si and Mn in a large proportion has a high tensile strength of 980 MPa or more and is excellent in all of galvanizability, formabilities and delayed fracture resistance, the inventors have paid attention, particularly, to a layer structure from an interface between its galvanized layer or galvannealed layer and the base steel sheet toward the base steel sheet side of the plated steel sheet, and have repeatedly made investigations. As a result, as shown in a schematic view of FIG. 1, which will be referred to later, the inventors have found out the following to attain the present invention:

(a) the layer structure from the interface between the galvanized layer or galvannealed layer and the base steel sheet toward the base steel sheet side is configured to have a soft layer including an internal oxidized layer including at least one an oxide of selected from the group consisting of Si and Mn, and a hard layer which is a region other than the soft layer, is mainly made of a low-temperature-transformation produced phase, and includes retained austenite, and which may include polygonal ferrite; and further

(b) when the average depth d of the internal oxidized layer is controlled into 4 μm or more to make the layer thick, the internal oxidized layer functions as a hydrogen trapping site, so that the steel sheet can be effectively restrained from undergoing hydrogen embrittlement to attain expected purposes, and

(c) preferably, when a relationship is appropriately controlled between the average depth d of the internal oxidized layer and the average depth D of the soft layer, which includes the region of the internal oxidized layer, the steel sheet is made even higher, particularly, in bendability.

In the present description, the plated steel sheet includes, in the category thereof, both of any hot-dip galvanized steel sheet and any hot-dip galvannealed steel sheet.

In the description, the base steel sheet means a steel sheet on which a hot-dip galvanized layer and a hot-dip galvannealed layer have not yet been formed. The plated steel sheet means a steel sheet having a base steel sheet having, on a surface thereof, a hot-dip galvanized layer or hot-dip galvannealed layer.

In the description, the wording “high-strength or high strength” means a tensile strength of 980 MPa or more.

In the description, the wording “excellent in formabilities” means that all of elongation, bendability and hole expandability are excellent. When these properties are measured by methods details of which will be described in Examples described later, any steel sheet satisfying acceptable standards therefor in the Examples is called a steel sheet “excellent in formabilities”.

As described above, the plated steel sheet of the present invention has, on a surface of its base steel sheet, a hot-dip galvanized layer or hot-dip galvannealed layer (hereinafter represented by a galvanized layer or galvannealed layer as the case may be). Characteristics of the present invention are points that the plated steel sheet has a layer structure of the following (A) to (C) from an interface between the base steel sheet and the galvanized layer or galvannealed layer toward the base steel sheet side of the plated steel sheet:

(A) An internal oxidized layer: the layer is a layer including at least one an oxide selected from the group consisting of Si and Mn. The average depth d of the internal oxidized layer is 4 μm or more, and is less than the average depth D of a soft layer described in the following item (B).

(B) A soft layer: the layer includes the internal oxidized layer, and has a Vickers hardness of 90% or less of a Vickers hardness of a portion of t/4 of the base steel sheet where “t” is a sheet thickness of the base steel sheet. The average depth D of the soft layer is 20 μm or more.

(C) A hard layer: the layer is composed of structure which are mainly made of a low-temperature-transformation produced phase and include retained γ, and which may include polygonal ferrite. The wording “low-temperature-transformation produced phase” means bainite and tempered martensite. In the present Description, the low-temperature-transformation produced phase does not include martensite which is quenched into the low-temperature-transformation produced phase and keeps this quenched state (the martensite may be called fresh martensite). In the Description, fresh martensite is classified into a structure other than the low-temperature-transformation produced phase for convenience' sake. The wording “being mainly made of a phase” means that when the structure fraction of the structure is measured by a method stated in Examples that will be described later, the structure fraction thereof is 70% or more by area of the whole of the metallic structure. Details thereof will be described later.

Referring to FIG. 1, the following will detail the structure of items (A) to (C), by which the present invention is characterized, in turn.

As illustrated in FIG. 1, the layer structure of the base steel sheet 2 side of a plated steel sheet of the present invention sequentially has, from an interface between a galvanized layer or galvannealed layer 1 and the base steel sheet 2 toward the base steel sheet 2, a soft layer 4 in item (B), and a hard layer 5 in item (C) on the base steel sheet 2 side and at a position inner from the soft layer 4. The soft layer in item (B) includes an internal oxidized layer 3 in item (A). The soft layer 4 and the hard layer 5 are continuously present.

(A) About Internal Oxidized Layer

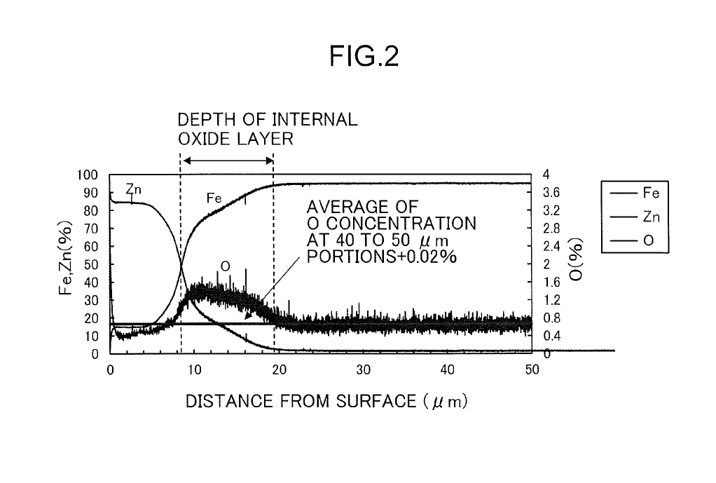

Firstly, the plated steel sheet has, in a portion thereof that contacts the interface between the galvanized layer or galvannealed layer 1 and the base steel sheet 2, the internal oxidized layer 3 having an average depth d of 4 μm or more. The average depth means the average of the depth of this layer from the interface. With reference to FIG. 2, details of a measuring method thereof will be stated in the section of the Examples described later.

The internal oxidized layer 3 is comprises at least one an oxide selected from the group consisting of Si and Mn, and a depletion layer of Si and Mn that has a peripheral portion in which solid-solutionized Si and/or solid-solutionized Mn are small in amount.

A maximum characteristic of the present invention is that the average depth d of the internal oxidized layer 3 is controlled into 4 μm or more to make the layer thick. In this way, the internal oxidized layer 3 can be used as a hydrogen trapping site so that the steel sheet can be restrained from undergoing hydrogen embrittlement and be improved in bendability, hole expandability and delayed fracture resistance. As in the present invention, in a base steel sheet including easily oxidizable elements such as Si and Mn in a large proportion, Si oxides, Mn oxides, and composite oxidized films including composite oxides of Si and Mn are easily formed on the surface of the base steel sheet at time of annealing the steel sheet to damage the steel sheet in galvanizability. The annealing time corresponds to an oxidizing and reducing step in a continuous hot-dip galvanizing line that will be described later. Thus, as a countermeasure thereagainst, known is a method of oxidizing a base steel sheet surface in an oxidizing atmosphere to produce an Fe oxidized film, and then subjecting the steel sheet to annealing (i.e., reduction annealing) in a hydrogen-containing atmosphere. Furthermore, known is a method of controlling an atmosphere in a furnace, thereby fixing an easily oxidizable element as an oxide inside a surface layer of a base steel sheet to decrease the easily oxidizable element solid-solutionized inside the base steel sheet surface layer, thereby preventing the easily oxidizable element from being made into an oxidized film on the base steel sheet surface layer.

However, the inventors have investigated to find out the following: in an oxidizing and reducing method used widely to plate a base steel sheet including Si and Mn in a large proportion, hydrogen invades the base steel sheet in the reduction, so that the steel sheet is deteriorated in bendability and hole expandability by hydrogen embrittlement in a hydrogen atmosphere in the reduction; and for solving this deterioration, it is effective to use at least one an oxide selected from the group consisting of Si and Mn. In detail, the oxide is effective as a hydrogen trapping site capable of preventing the hydrogen invasion into the base steel sheet, and solving the deterioration in the bendability and the hole expandability, which is caused by a decline in the delayed fracture resistance. In order to cause this advantageous effect to be effectively exhibited, the inventors have made it evident that it is essential to form the internal oxidized layer including the oxide thickly to set the average depth d thereof to 4 μm or more. The d value is preferably 6 μm or more, more preferably 8 μm or more, even more preferably more than 10 μm.

In the present invention, the upper limit of the average depth d of the internal oxidized layer 3 is, at least, less than the average depth D of the soft layer 4 in item (B), which will be described later. The upper limit of the d value is preferably 30 μm or less. In order to make the internal oxidized layer 3 thick, the steel sheet needs to be retained in a high temperature range for a long period after hot-rolled and coiled. A reason for the upper limit is that restrictions about productivity and facilities can substantially give the preferred value. The d value is more preferably 18 μm or less, even more preferably 16 μm or less.

In the present invention, it is further preferred about a relationship between the average depth d of the internal oxidized layer 3 and the average depth D of the soft layer 4 in item (B), which will be described later, that a control is made to satisfy the relationship expression of D>2d. This case makes, particularly, the bendability far better.

In contrast, Patent Literature 2 described above discloses a hot-dip galvanized steel sheet in which about the existence depth d of an oxide and the thickness D of a soft layer, which correspond substantially to the average depth d and the average depth D of the soft layer, which are described in the present invention, d/4≦D≦2d is satisfied. This expression is entirely different in control directivity from the relational expression (D>2d) specified in the invention. Patent Literature 2 also states that the range of the existence depth d of the oxide is controlled while the steel sheet is basically caused to satisfy the relationship of d/4≦D≦2d; and never has a basic idea that the internal oxidized layer 3 is made thick to control the average depth d of this layer to 4 μm or more as in the present invention. Of course, Patent Literature 2 does not describe the advantageous effect of the invention that this control causes the hydrogen trapping site effect to be effectively exhibited to improve the bendability, hole expandability and delayed fracture resistance.

In the present invention, in order to control the average depth d of the internal oxidized layer 3 to 4 μm or more, it is necessary to control the average depth of the internal oxidized layer 3 to 4 μm or more in the cold-rolled steel sheet before the steel sheet is passed through a continuous hot-dip galvanizing line. A reason therefor is that as described in the Examples, which will be stated later, the internal oxidized layer in a plated steel sheet obtained finally after the passing through the galvanizing line takes over the internal oxidized layer of the steel sheet which has been pickled and cold-rolled. Details thereof will be described together with methods for producing the plated steel sheet.

(B) About Soft Layer

As illustrated in FIG. 1, the soft layer 4 in the present invention is a layer including a region of the internal oxidized layer 3 in item (A). This soft layer 4 satisfies a requirement that a Vickers hardness thereof satisfies 90% or less of a Vickers hardness of a portion of t/4 of the base steel sheet 2, where “t” is a sheet thickness (mm) of the base steel sheet. Details of the Vickers hardness will be stated in the section Examples, which will be described later.

The soft layer 4 is made of a soft structure lower in Vickers hardness than the hard layer 5 in item (C), which will be described later. This layer is excellent in deformability so that the steel sheet is improved, particularly, in bendability by the formation of the soft layer 4. In other words, when the steel sheet is bent, surface layer portion of the base steel sheet functions as starting points of cracks. However, as in the present invention, the predetermined soft layer 4 is formed in the base steel sheet surface layer, thereby improving, particularly, the bendability. Furthermore, the formation of the soft layer 4 makes it possible to prevent the oxide in item (A) from becoming starting points of cracks at the bending time, so that the present invention can gain only the advantage of the function as the hydrogen trapping site. As a result, the steel sheet is made far better in delayed fracture resistance as well as bendability.

In order to cause the steel sheet to exhibit such advantages based on the soft layer formation, the average depth D of the soft layer 4 is set to 20 μm or more. The D value is preferably 22 μm or more, more preferably 24 μm or more. If the average depth D of the soft layer 4 is too large, the strength of the plated steel sheet itself is lowered. Thus, the upper limit thereof is preferably 100 μm or less, more preferably 60 μm or less.

(C) About Hard Layer

As illustrated in FIG. 1, in the present invention, the hard layer 5 is formed on the base steel sheet 2 side of the soft layer 4 in item (B). This hard layer 5 consists of structure which are mainly composed of a low-temperature-transformation produced phase and include retained γ, and which may include polygonal ferrite.

(C1) The “low-temperature-transformation produced phase” means bainite and tempered martensite. Bainite includes, in a meaning thereof, bainitic ferrite. Bainite is a structure in which a carbide is precipitated. Bainitic ferrite is a structure in which no carbide is precipitated.

The above-mentioned wording “are mainly made of a low-temperature-transformation produced phase” means that when metallic structure is observed through a scanning electron microscope, the proportion of the low-temperature-transformation produced phase is 70% or more by area of the whole of the metallic structure. The proportion by area of the low-temperature-transformation produced phase is preferably 75% or more, more preferably 80% or more, even more preferably 85% or more by area. The upper limit of the proportion by area of the low-temperature-transformation produced phase is preferably, for example, 95% or less by area to cause the steel sheet to ensure the produced amount of retained γ.

(C2) The retained γ has an advantageous effect of being transformed to martensite when the steel sheet receives stress to be deformed, thereby promoting the hardening of the deformed portion to prevent the concentration of strain thereto. In this way, the steel sheet is improved in deformabilities evenness to exhibit a good elongation. This advantageous effect is generally called TRIP effect.

In order to cause the steel sheet to exhibit the advantageous effect, the retained γ needs to be incorporated into a proportion of 5% or more by volume of the whole of the metallic structure when the metallic structure is measured by a saturation magnetization method. The proportion of the retained γ is preferably 8% or more, more preferably 10% or more, even more preferably 12% or by volume. However, if the produced amount of the retained γ is too large, an MA mixed phase, which will be described later, is also excessively produced so that grains of the MA mixed phase easily become coarse. Consequently, the steel sheet is lowered in localized deformabilities (hole expansibility and bendability). Thus, the upper limit of the proportion of the retained γ is about 30% or less, more preferably 25% or less by volume.

The retained γ is produced mainly between laths of the metal structure. However, the retained γ may be present as portions of the MA mixed phase, which will be described later, in the form of lumps on lath-form-microstructure aggregates of, for example, blocks or packets, or on grain boundaries of prior austenite.

(C3) The hard layer may include polygonal ferrite in a proportion from 0% to 10% both inclusive by area of the whole of the metallic structure when the metallic structure is observed through a scanning electron microscope. If the produced amount of the polygonal ferrite is excessive, the bendability and the hole expandability are deteriorated. Thus, the proportion by area of the polygonal ferrite is preferably 10% or less, more preferably 8% or less, even more preferably 5% or less of the whole of the metallic structure.

(C4) The hard layer may include, besides the above-mentioned structure, other structure that may be inevitably incorporated into the layer in the production of the steel sheet, such as perlite and tempered martensite, as far as the structure do not damage the effects of the present invention. The hard layer may also include an MA mixed phase, which is a composite phase of tempered martensite and retained γ. The proportion of the other structure is preferably at most 15% or less by area. As the proportion is smaller, a preferred result is given to the steel sheet.

(C5) As described above, the formation of the hard layer improves the steel sheet in elongation and hole expandability. In other words, when holes in the steel sheet are expanded, the steel sheet is generally cracked by the concentration of stress in the interface between the hard phase such as hainite and the soft phase such as polygonal ferrite. It is therefore necessary to decrease a difference in hardness between the hard phase and the soft phase to restrain the cracks. Thus, in the present invention, structure inside the base steel sheet is rendered the hard layer, which is mainly made of a low-temperature-transformation produced phase such as bainite as a hard phase, and which may include polygonal ferrite as a soft phase in a restrained occupation proportion that is, at most, 10% or less by area.

(C6) In the present invention, bainite constituting the low-temperature-transformation produced phase is preferably distinguished between high-temperature-range produced bainite and low-temperature-range produced bainite. In other words, it is preferred for the low-temperature-transformation produced phase (C6-1) to include mainly high-temperature-range produced bainite, (C6-2) to include high-temperature-range produced bainite, low-temperature-range produced bainite and tempered martensite, or (C6-3) to include mainly low-temperature-range produced bainite and tempered martensite.

The high-temperature-range produced bainite is a structure in which the average interval between adjacent grains of retained austenite, between adjacent grains of any carbide or between adjacent grains of the retained austenite and the carbide is 1 μm or more when a cross section of the steel sheet that is subjected to nital corrosion is observed through a scanning electron microscope. The high-temperature-range produced bainite is a bainite structure produced in a temperature range of about 400 to 540° C. both inclusive while the steel sheet is cooled, after heated, to a temperature of the A_{c1} or higher.

The low-temperature-range produced bainite is a structure in which the average interval between adjacent grains of retained austenite, between adjacent grains of any carbide or between adjacent grains of the retained austenite and the carbide is less than 1 μm when a cross section of the steel sheet that is subjected to nital corrosion is observed through a scanning electron microscope. The low-temperature-range produced bainite is a bainite structure produced in a temperature range of about 200° C. or higher and lower than about 400° C. while the steel sheet is cooled, after heated, to a temperature of the A_{c1} or higher.

The tempered martensite is a structure having substantially the same effect as the low-temperature-range produced bainite. The low-temperature-range produced bainite and the tempered martensite cannot be distinguished from each other even when these are observed through a scanning electron microscope. In the present invention, the low-temperature-range produced bainite and the tempered martensite are together called “low-temperature-range produced bainite analogs”.

The high-temperature-range produced bainite contributes to an improvement of the steel sheet in, particularly, elongation out of mechanical properties. The low-temperature-range produced bainite and the tempered martensite contribute to an improvement of the steel sheet in, particularly, hole expandability of the mechanical properties.

When the steel sheet includes these two, i.e., the bainite structure and the tempered martensite, the steel sheet can ensure a good hole expandability and can be further improved in elongation to be heightened in the whole of formabilities. This would be because the bainite structure and the tempered martensite, which are different in strength level from each other, are made composite with each other to generate uneven deformation so that the steel sheet is heightened in work hardenability. In other words, the high-temperature-range produced bainite is softer than the low-temperature-range produced bainite analogs to heighten the elongation EL of the steel sheet to contribute to the formability thereof. The low-temperature-range produced bainite analogs have small carbide and retained γ grains. Thus, when the steel sheet is deformed, the analogs are decreased in stress concentration to heighten the steel sheet in hole expandability and bendability to improve the steel sheet in local deformabilities followed by formability. By causing the high-temperature-range produced bainite and the low-temperature-range produced bainite analogs to coexist, the steel sheet is improved in working hardenability to be improved in elongation followed by formability.

The following will detail the high-temperature-range produced bainite, and the low-temperature-range produced bainite analogs.

The between-central-position distance between adjacent grains of the retained austenite, between adjacent grains of any carbide or between adjacent grains of the retained austenite and the carbide may be collectively referred to as the “average interval between grains of the retained γ or the like”. The between-central-position distance denotes that the following distance obtained when a measurement is made between adjacent and nearest grains of the retained austenite, between adjacent and nearest grains of any carbide or between adjacent and nearest grains of the retained austenite and the carbide, and then respective central positions of the retained γ grains or the carbide grains are gained: the distance between the central positions. Each of the central positions is defined as the following position when the long diameter and the short diameter of each of the grains of the retained γ or the carbide are determined: a position where the long diameter and the short diameter cross each other.

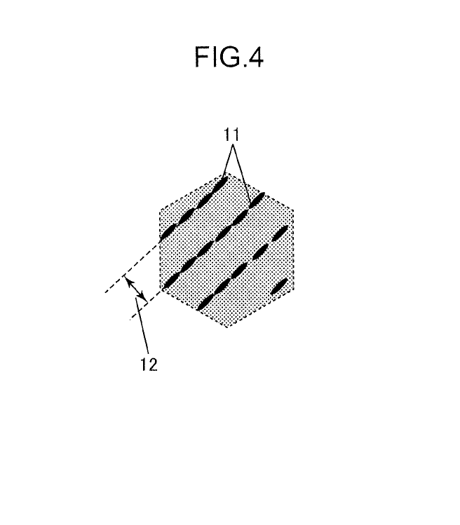

However, when plural retained γ grains and carbide grains are precipitated on boundaries of laths, the retained γ grains and the carbide grains lie in lines, and the form thereof becomes a needle or plate form. Thus, the between-central-position distance is not the distance between adjacent grains of the retained γ, adjacent grains of the carbide, or adjacent grains of the retained γ and the carbide. As illustrated in FIG. 4, it is sufficient for the between-central-position distance 12 to be defined by the interval between lines formed by the matter that the retained γ grains and the carbide grains, or the retained γ grains or the carbide grains lie in a line form in the long axis direction. The interval between the lines may be called the between-lath distance. In FIG. 4, reference number 11 represents the retained γ grains or carbide grains.

In the present invention, the reason why bainite is classified, as described above, to “high-temperature-range produced bainite” and “low-temperature-range produced bainite analog” in accordance with a difference between production temperature ranges therefor, and the average interval between the retained γ grains or the like is that species of bainite are not clearly distinguished from each other with ease according to any general academic classification. Lath-form bainite and bainitic ferrite are classified, in accordance with the transformation temperature thereof, to upper bainite and lower bainite, respectively. However, in steel species containing Si in a large proportion of 1% or more as in the present invention, the precipitation of a carbide that follows bainite transformation is restrained to make it difficult to distinguish these structures including a martensite structure from each other by observation through a scanning electron microscope. Thus, in the present invention, bainite is classified not by any academic structure definition but by the difference between the production temperature range, and the average interval between the retained γ grains or the like as described above.

The average interval is largely affected by the retention temperature of the steel sheet. However, the lath form of the bainite structure is in a flat plate form, so that the above-mentioned interval is observed as a small or large interval in accordance with the observed surface. Accordingly, the proportion by area of each of bainite species produced, respectively, in a high temperature range and a low temperature range is stipulated as a proportion including a variation in the interval according to the direction of the observation.

The distribution state of the high-temperature-range produced bainite, and the low-temperature-range produced bainite analogs is not particularly limited. Thus, for example, both of high-temperature-range produced bainite and low-temperature-range produced bainite analogs may be produced in each grain of prior austenite; or high-temperature-range produced bainite and low-temperature-range produced bainite analogs are produced in respective prior austenite grains.

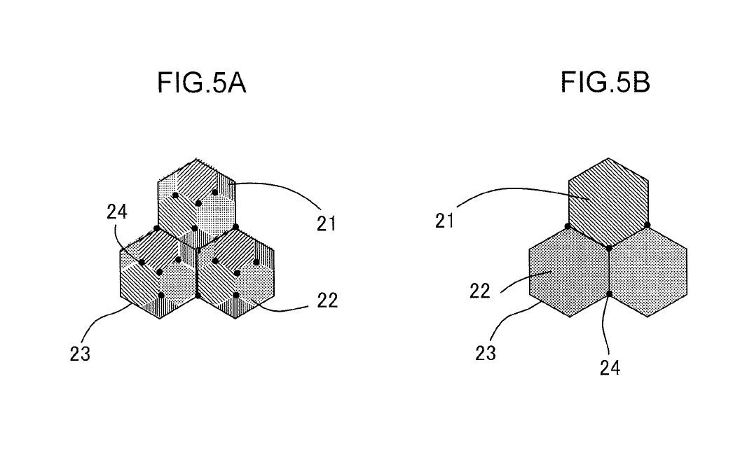

A distribution state of high-temperature-range produced bainite and low-temperature-range produced bainite analogs is schematically illustrated in FIGS. 5A and 5B. In FIGS. 5A and 5B, reference number 21 represents a high-temperature-range produced bainite grain; 22, a low-temperature-range produced bainite analog grain; 23, prior austenite (prior γ grain boundaries); and 24, an MA mixed phase grain. In FIGS. 5A and 5B, high-temperature-range produced bainite grains are hatched; and small dots are attached to low-temperature-range produced bainite analog grains. FIG. 5A shows a state that both of high-temperature-range produced bainite grains and low-temperature-range produced bainite analog grains are produced in a mixed state in each prior austenite grain. FIG. 5B shows a state that each of a high-temperature-range produced bainite grain, and low-temperature-range produced bainite analog grains are produced in prior austenite grains, respectively. In FIGS. 5A and 5B, black dots represent MA mixed phase grains. The MA mixed phase will be described later.

The present invention may be in the case of any one of the following items (C6-1), (C6-2) and (C6-3):

(C6-1) the low-temperature-transformation produced phase includes high-temperature-range produced bainite, the proportion of the high-temperature-range produced bainite is more than 50% by area and 95% or less by area of the whole of the metallic structure, the low-temperature-transformation produced phase may include low-temperature-range produced bainite and tempered martensite, and the proportion of the total of the low-temperature-range produced bainite and the tempered martensite is of 0% or more by area and less than 20% by area of the whole of the metallic structure;

(C6-2) the low-temperature-transformation produced phase includes high-temperature-range produced bainite, low-temperature-range produced bainite and tempered martensite, the proportion of the high-temperature-range produced bainite is from 20 to 80% by area of the whole of the metallic structure, and the proportion of the total of the low-temperature-range produced bainite and the tempered martensite is from 20 to 80% by area of the whole of the metallic structure; and

(C6-3) when the low-temperature-transformation produced phase may include low-temperature-range produced bainite and tempered martensite, the proportion of the total of the low-temperature-range produced bainite and the tempered martensite is more than 50% by area and 95% or less by area of the whole of the metallic structure, the low-temperature-transformation produced phase may include high-temperature-range produced bainite, and the proportion of the high-temperature-range produced bainite is 0% or more by area and less than 20% by area of the whole of the metallic structure.

In the case (C6-1), by adjusting the produced amount of the high-temperature-range produced bainite to more than 50% by area, the steel sheet can be improved in elongation to be improved in formabilities. Thus, the proportion of the high-temperature-range produced bainite is preferably more than 50%, more preferably 65% or more, even more preferably 75% or more, in particular preferably 80% or more by area. However, if the produced amount of the high-temperature-range produced bainite is excessive, the produced amount of retained γ is not easily ensured. Thus, the proportion of the high-temperature-range produced bainite is preferably 95% or less, more preferably 90% or less, even more preferably 85% by area.

In the case (C6-2), by adjusting the produced amount “a” of the high-temperature-range produced bainite to 20% or more by area, the steel sheet is improved in elongation, and by adjusting the produced amount “b” of the low-temperature-range produced bainite analogs to 20% or more by area, the steel sheet is improved in hole expandability, so that formabilities thereof can be improved. Thus, the proportion of the high-temperature-range produced bainite is preferably 20% or more, more preferably 25% or more, even more preferably 30% or more, in particular preferably 40% or more by area. The proportion of the low-temperature-range produced bainite is preferably 20% or more, more preferably 25% or more, even more preferably 30% or more, in particular preferably 40% or more by area. However, if the produced amount “a” of the high-temperature-range produced bainite and that “b” of the low-temperature-range produced bainite analogs are excessive, the produced amount of retained γ is not easily ensured. Thus, the proportion of the high-temperature-range produced bainite is preferably 80% or less, more preferably 75% or less, even more preferably 70% or less by area. The proportion of the low-temperature-range produced bainite analogs is preferably 80% or less, more preferably 75% or less, even more preferably 70% or less by area.

The relationship between the produced amount “a” and the produced amount “b” is not particularly limited as far as the respective ranges thereof satisfy the above-mentioned ranges. The relationship also includes respective embodiments of a>b, a<b, and a=b.

The blend ratio between the high-temperature-range produced bainite and the low-temperature-range produced bainite analogs may be sufficient to be determined in accordance with properties required for the steel sheet. Specifically, in order to make the hole expandability out of formabilities of the steel sheet far better, the proportion of the high-temperature-range produced bainite is made as small as possible and that of the low-temperature-range produced bainite analogs is made as large as possible. In the meantime, in order to make the elongation out of formabilities of the steel sheet far better, the proportion of the high-temperature-range produced bainite is made as large as possible and that of the low-temperature-range produced bainite analogs is made as small as possible. In order to make the strength of the steel sheet far higher, the proportion of the low-temperature-range produced bainite analogs is made as large as possible and that of the high-temperature-range produced bainite is made as small as possible.

In the case (C6-3), by adjusting the produced amount of the low-temperature-range produced bainite analogs to more than 50% by area, the steel sheet can be improved in hole expandability to be improved in formabilities. Thus, the proportion of the low-temperature-range produced bainite analogs is preferably more than 50%, more preferably 65% or more, even more preferably 75% or more, in particular preferably 80% or more by area. However, if the produced amount of the low-temperature-range produced bainite analogs is excessive, the produced amount of retained γ is not easily ensured. Thus, the proportion of the low-temperature-range produced bainite analogs is preferably 95% or less, more preferably 90% or less, even more preferably 85% by area.

When the low-temperature-transformation produced phase includes the MA mixed phase in the cases (C6-2) and (C6-3), the proportion of the number of grains of the MA mixed phase that each have an equivalent circular diameter more than 5 μm is preferably 0% or more and less than 15% of the number of the entire grains of the MA mixed phase.

The MA mixed phase is generally known as a composite phase of tempered martensite and retained γ, and is a structure produced by the matter that a structure present as non-transformed austenite before final cooling of the steel sheet is partially transformed to martensite at the time of the final cooling time, and further the rest of the structure remains, as it is, austenite. In the MA mixed phase, carbon has been concentrated into a high concentration, particularly, in the step of an austempering treatment, and further the MA mixed phase has been partially turned to a martensite structure; thus, the MA mixed phase is a very hard structure. Thus, the difference in hardness between bainite and the MA mixed phase is large, so that when the steel sheet is deformed, stress is concentrated thereinto. Consequently, the concentrated points easily become starting points of void-generation. Thus, if the MA mixed phase is excessively produced, the steel sheet is lowered in hole expandability and bendability to be lowered in local deformabilities. Moreover, if the MA mixed phase is excessively produced, the steel sheet tends to be too high in strength. The MA mixed phase is more easily produced as the amount of retained γ therein becomes larger and further the Si amount therein becomes larger. It is preferred that the produced amount of the MA mixed phase is as small as possible.

About the MA mixed phase, it is preferred that the proportion of the number of grains of the MA mixed phase that each have an equivalent circular diameter more than 5 μm is 0% or more and less than 15% of the number of the entire grains of the MA mixed phase. The coarse grains of the MA mixed phase, which each have an equivalent circular diameter more than 5 μm, produce a bad effect onto the local deformabilities.

As the diameter of grains of the MA mixed phase is larger, voids are more easily produced therein. This tendency has been verified by experiments. Thus, it is recommended that the grains of the MA mixed phase are as small as possible.

The above-mentioned metallic structure can be measured by the following steps:

About high-temperature-range produced bainite, low-temperature-range produced bainite analogs (low-temperature-range produced bainite+tempered martensite), polygonal ferrite, and perlite, their cross section parallel to the rolled direction of the steel sheet is subjected to nital corrosion at a position of the section that has a thickness of ¼ of the sheet thickness, and the position is observed through a scanning electron microscope at a magnification of about 3000. In this way, these structures can be distinguished from each other.

High-temperature-range produced bainite, and low-temperature-range produced bainite analogs are observed mainly as gray areas, and as structures in which white or thinly gray retained γ or the like is dispersed in crystal grains. Thus, according to scanning electron microscopic observation, the bainite or the analogs include the retained γ or the like; therefore, the proportion by area of the high-temperature-range produced bainite or the low-temperature-range produced bainite analogs is calculated as the proportion by area of the bainite or the analogs including retained γ or the like.

Polygonal ferrite is observed as crystal grains including therein no white or thinly gray retained γ or the like as described above. Perlite is observed as a structure in which any carbide and ferrite are in a layer form.

When a cross section of the steel sheet is subjected to nital corrosion, any carbide and retained γ therein are each observed as a white or thinly gray structure. Thus, the two are not easily distinguished from each other. The carbide such as cementite out of these structures has a tendency that grains thereof are produced more largely inside laths than between the laths as the grains are produced in a lower temperature range. Thus, when the interval between the carbide grains is wide, the grains would have been produced in a high temperature range. When the interval between the carbide grains is narrow, the grains would have been produced in a low temperature range. Retained γ is usually produced between laths. The size of the laths becomes smaller as the production temperature of the structure is lower. Thus, when the interval between retained γ grains is wide, the grains would have been produced in a high temperature range. When the interval between the retained γ grains is narrow, the grains would have been produced in a low temperature range. In the present invention, therefore, a cross section of the steel sheet that has been subjected to nital corrosion is observed through a scanning electron microscope, and attention is paid to retained γ or the like observed as white or thinly gray areas in visual fields for the observation. When the between-central-position distance between the retained γ grains or the like is measured, any structure in which this average interval is 1 μm or more is determined to be high-temperature-range produced bainite. Any structure in which this average interval is less than 1 μm is determined to be low-temperature-range produced bainite analogs.

About retained γ, the structure thereof cannot be identified by scanning electron microscopic observation. Thus, the proportion by volume thereof is measured by a saturation magnetization method. The value of this proportion by volume can be read with the proportion by area thereof. About details of a measurement principle of the saturation magnetization method, it is advisable to refer to “R & D Kobe Steel, Ltd. Technical Report, Vol. 52, No. 3, 2002, pp 43-46”.

As described just above, the proportion by volume of retained γ is measured by the saturation magnetization method while the proportion by area of high-temperature-range produced bainite and that of low-temperature-range produced bainite analogs are each measured, through scanning electron microscopic observation, as that of the high-temperature-range produced bainite or the low-temperature-range produced bainite analogs which include retained γ. Thus, the total of the proportions may be more than 100%.

About the MA mixed phase, its cross section parallel to the rolled direction of the steel sheet is subjected to Lepera corrosion at a position of the section that has a thickness of ¼ of the sheet thickness, and the position is observed through an optical microscope at a magnification of about 1000. In this case, the MA mixed phase is observed as a white structure. On the basis of this result, it is advisable to calculate out the above-mentioned proportion of the number of grains of the MA mixed phase that each have an equivalent circular diameter more than 5 μm.

The above has described the layer structure from the interface between the galvanized layer or galvannealed layer and the base steel sheet toward the base steel sheet side, the present invention being most largely characterized by this layer structure.

The following will describe the composition of components of the base steel sheet used in the present invention.

The base steel sheet includes C: 0.10 to 0.5%, Si: 1 to 3%, Mn: 1.5 to 8%, Al: 0.005 to 3%, P: more than 0% to 0.1% or less, S: more than 0% to 0.05% or less, N: more than 0% to 0.01% or less, and iron and inevitable impurities as the balance.

C is an element necessary for heightening the strength of the steel sheet, and producing retained γ. In the present invention, the C amount is 0.10% or more, preferably 0.13% or more, more preferably 0.15% or more. However, if the steel sheet includes C excessively, the weldability thereof is lowered. Thus, the C amount is 0.5% or less, preferably 0.4% or less, more preferably 0.3% or less.

Si contributes, as a solute strengthening element, to an improvement of the steel sheet in strength, and is further a very important element for restraining the precipitation of any carbide while the steel sheet is retained in a temperature range of 100 to 540° C. (while austempered), thereby producing retained γ effectively. In the present invention, the Si amount is 1% or more, preferably 1.1% or more, more preferably 1.2% or more. However, if the steel sheet includes Si excessively, the steel sheet does not undergo reverse transformation to a γ phase where steel sheet is heated and soaked while annealed. Consequently, polygonal ferrite remains in a large amount. Thus, the steel sheet becomes short in strength. Moreover, when the steel sheet is hot-rolled, Si scales are generated in surfaces of the steel sheet to deteriorate surface natures of the steel sheet. Thus, the Si amount is 3% or less, preferably 2.5% or less, more preferably 2.0% or less.

Mn is an element necessary for yielding bainite and tempered martensite. Mn is also an element acting effectively for stabilizing γ to produce retained γ. In the present invention, the Mn amount is 1.5% or more, preferably 1.8% or more, more preferably 2.0% or more. However, if the steel sheet includes Mn excessively, the production of high-temperature-range produced bainite, out of bainite species, is remarkably restrained. The excessive-amount addition of Mn causes the steel sheet to be deteriorated in weldability, and deteriorated in formability by segregation. Thus, the Mn amount is 8% or less, preferably 7% or less, more preferably 6% or less, even more preferably 5.0% or less, in particular preferably 3% or less.

In the same manner as Si, Al is an element for restraining any carbide from being precipitated in the austempering treatment to contribute to the production of retained γ. Al is also an element acting as a de-oxidizing agent in a steel making process. In the present invention, the Al amount is 0.005% or more, preferably 0.01% or more, more preferably 0.03% or more. However, if the steel sheet includes Al excessively, the steel sheet comes to contain therein an excessive amount of inclusions to be deteriorated in ductility. Thus, the Al amount is 3% or less, preferably 1.5% or less, more preferably 1% or less, even more preferably 0.5% or less, in particular preferably 0.2% or less.

P is an impurity element contained inevitably in any steel. An excessive amount of P causes the steel sheet to be deteriorated in weldability. Thus, the P amount is 0.1% or less, preferably 0.08% or less, more preferably 0.05% or less. It is preferred that the P amount is as small as possible. However, it is industrially difficult to set the amount to 0%.

In the same manner as P, S is an impurity element contained inevitably in any steel. If the S amount is excessive, the steel sheet is deteriorated in weldability. Moreover, S causes the production of sulfide inclusions in the steel sheet. When the amount thereof increases, the steel sheet is lowered in formability. In the present invention, the S amount is 0.05% or less, preferably 0.01% or less, more preferably 0.005% or less. It is preferred that the S amount is as small as possible. However, it is industrially difficult to set the amount to 0%.

In the same manner as P, N is an impurity element contained inevitably in any steel. If the steel sheet includes N excessively, the steel sheet undergoes the precipitation of a large amount of nitrides to be deteriorated in elongation, hole expandability, and bendability. In the present invention, the N amount is 0.01% or less, preferably 0.008% or less, more preferably 0.005% or less. It is preferred that the N amount is as small as possible. However, it is industrially difficult to set the amount to 0%.

The high-strength steel sheet according to the present invention satisfies the above-mentioned component composition. Components of the balance thereof are iron and inevitable impurities other than the above-mentioned elements P, S and N.

Examples of the inevitable impurities include O (oxygen), and tramp elements such as Pb, Bi, Sb, and Sn.

About O, out of the inevitable impurities, the amount thereof is preferably, for example, more than 0% and 0.01% or less. O is an element such that if the steel sheet contains O excessively, the steel sheet is lowered in elongation, hole expandability and bendability. Thus, the O amount is preferably 0.01% or less, more preferably 0.008% or less, even more preferably 0.005% or less.

The steel sheet of the present invention may further include, as other elements, for example, the following:

any one of the following:

(a) one or more elements selected from the group consisting of Cr: more than 0%, and 1% or less, Mo: more than 0%, and 1% or less, and B: more than 0%, and 0.01% or less;

(b) one or more elements selected from the group consisting of Ti: more than 0%, and 0.2% or less, Nb: more than 0%, and 0.2% or less, and V: more than 0%, and 0.2% or less;

(c) one or more elements selected from the group consisting of Cu: more than 0%, and 1% or less, and Ni: more than 0%, and 1% or less; and

(d) one or more elements selected from the group consisting of Ca: more than 0%, and 0.01% or less, Mg: more than 0%, and 0.01% or less, and any rare earth element: more than 0%, and 0.01% or less.

(a) In the same manner as Mn, Cr, Mo and B are elements acting effectively for yielding bainite and tempered martensite. These elements may be singly added to the steel sheet, or two or more thereof may be used. In order to cause the steel sheet to exhibit such effects effectively, it is preferred that Cr and Mo are each independently incorporated thereinto in an amount of 0.1% or more. The amount is preferably 0.2% or more. B is preferably incorporated thereinto in an amount of 0.0005% or more. The amount is more preferably 0.001% or more. However, if the steel sheet includes each of the elements excessively, the production of high-temperature-range produced bainite, out of bainite species, is remarkably restrained. Moreover, the excessive-amount incorporation increases costs. In particular, the excessive-amount incorporation of B causes the production of a boride in the steel sheet to deteriorate the ductility thereof. Thus, the amount of each of Cr and Mo is preferably 1% or less, more preferably 0.8% or less, even more preferably 0.5% or less. When Cr and Mo are together used, it is recommended to set the total amount to 1.5% or less. The B amount is preferably 0.01% or less, more preferably 0.005% or less, even more preferably 0.004% or less.

(b) Ti, Nb and V are elements acting to produce precipitations such as carbides and nitrides in the steel sheet to strengthen the steel sheet. In order to cause the steel sheet to exhibit such effects effectively, it is preferred that Ti, Nb and V are each independently incorporated thereinto in an amount of 0.01% or more. The amount is more preferably 0.02% or more. However, if these elements are excessively incorporated thereinto, the steel sheet undergoes, in its grain boundaries, the precipitation of carbides to be deteriorated in hole expandability and bendability. Thus, in the present invention, the amount of each of Ti, Nb and V is preferably 0.2% or less, more preferably 0.18% or less, even more preferably 0.15%. Ti, Nb and V may be singly incorporated into the steel sheet, or two or more elements selected at will therefrom may be incorporated thereinto.

(c) Cu and Ni are elements acting effectively for stabilizing γ to produce retained T. These elements may be singly or in combination. In order to cause the steel sheet to exhibit such effects effectively, it is preferred that Cu and Ni are each independently incorporated thereinto in an amount of 0.05% or more. The amount is more preferably 0.1% or more. However, if Cu and Ni are excessively incorporated thereinto, the steel sheet is deteriorated in hot formability. Thus, in the present invention, the amount of each of Cu and Ni is set preferably to 1% or less, more preferably to 0.8% or less, even more preferably 0.5% or less. When Cu is incorporated thereinto in an amount over 1%, the hot formability is deteriorated. However, the addition of Ni restrains a deterioration of the hot formability; thus, when Cu and Ni are together used, the addition amount of Cu may be more than 1% although costs are increased.

(d) Ca, Mg and any rare earth element (REM) are elements acting to cause inclusions in the steel sheet to be finely dispersed. In order to cause the steel sheet to exhibit such effects effectively, it is preferred that Ca, Mg and rare earth element are each independently incorporated thereinto in an amount of 0.0005% or more. The amount is more preferably 0.001% or more. However, an excessive-amount incorporation thereof causes the steel sheet to be deteriorated in forgeability, hot formability and others. Thus, the steel sheet is not easily produced. The excessive-amount addition also causes the steel sheet to be deteriorated in ductility. Thus, in the present invention, the amount of each of Ca, Mg and the rare earth element is preferably 0.01% or less. The amount is more preferably 0.005% or less, even more preferably 0.003% or less. Ca, Mg and rare earth elements may be singly incorporated or two or more selected at will selected therefrom may be incorporated into the steel sheet.

The rare earth elements denote, as examples thereof, lanthanoid elements, which are 15 elements from La to Lu; and Sc (scandium) and Y (yttrium). Out of these elements, at least one selected from the group consisting of La, Ce and Y is preferably incorporated to the steel sheet.

At least one selected from the group consisting of La and Ce is more preferably incorporated thereinto.

The above has described the component composition of the base steel sheet used in the present invention.

The following will describe a method according to the present invention for a plated steel sheet.

The producing method according to the present invention includes, as aspects thereof, a first producing method of hot-rolling and coiling a base steel sheet and immediately pickling the sheet without keeping the temperature of the sheet, and a second producing method of hot-rolling and coiling a base steel sheet, keeping the temperature of the sheet thereafter, and then pickling the sheet. In accordance with the presence or absence of the temperature keeping, the first producing method and the second producing are different from each other in lower limit of the temperature for the hot rolling and the coiling. These methods have the same process except this difference. Hereinafter, the methods will be described in detail.

[First Producing Method (without Temperature Keeping)]

The first producing method according to the present invention is roughly divided to a hot rolling step, a pickling step and a cold rolling step; and an oxidizing step, a reducing step, a cooling step, and a galvanizing or galvannealing step in a continuous galvanizing line [CGL]. The characteristics of the present invention are in that the method has the following steps in the order of the described steps: a hot-rolling step of coiling a steel sheet having the steel components of the above-mentioned base steel sheet at a temperature of 600° C. or higher; a step of pickling and cold-rolling the steel sheet such that there remain the internal oxidized layer with an average depth d of 4 μm or more; a step of oxidizing the steel sheet at an air ratio of 0.9 to 1.4 in an oxidizing zone; a step of soaking the steel sheet in a temperature range not lower the A_{c3} point of the steel sheet in a reducing zone; a step of cooling, after the soaking, down to any stopping temperature Z satisfying a temperature from 100 to 540° C., and cooling the steel sheet, in a temperature range from 750° C. to a higher temperature of the stopping temperature Z or 500° C., at an average cooling rate of 10° C./second or more, and retaining the steel sheet in the above-mentioned temperature range of 100 to 540° C. for 50 seconds or longer. Hereinafter, the method will be described in the order of its steps.

Initially, a hot-rolled steel sheet is prepared which has the steel components of the above-mentioned base steel sheet.

It is sufficient for the hot rolling to be performed according to an ordinary method. For example, the heating temperature therefor is preferably set into about 1150 to 1300° C. to prevent austenite grains from becoming coarse.

The finish rolling temperature is preferably controlled to about 850 to 950° C.

In the present invention, it is important to control the temperature for the coiling after the hot rolling to 600° C. or higher. In this way, an internal oxidized layer is formed in surfaces of the base steel sheet, and further the steel sheet is decarbonized to form a soft layer. Accordingly, in the resultant galvanized or galvannealed steel sheet, a desired internal oxidized layer and soft layer can be obtained. If the coiling temperature is lower than 600° C., the internal oxidized layer and the soft layer are not sufficiently produced. Moreover, the hot-rolled steel sheet is heightened in strength to be lowered in cold rollability. The coiling temperature is preferably 620° C. or higher, more preferably 640° C. or higher. However, if the coiling temperature is too high, mill scales grow excessively so that the scales cannot be melted in pickling, which is a subsequent step. The upper limit thereof is preferably set to 750° C. or lower.

Next, the thus obtained hot-rolled steel sheet is pickled and cold-rolled to cause the internal oxidized layer with an average depth d of 40 μm or more. In this way, not only the internal oxidized layer but also the soft layer remains. Thus, after the steel sheet is galvanized or galvannealed, a desired soft layer is easily produced. It is known that by controlling conditions for the pickling, the thickness of the internal oxidized layer is controlled. Specifically, in order that the internal oxidized layer can ensure a desired thickness, it is advisable to control the temperature and the period for the pickling, and other factors appropriately in accordance with, for example, the species and the concentration of a pickling liquid to be used.

The pickling liquid may be a mineral acid such as hydrochloric acid, sulfuric acid, or nitric acid.

When the concentration or the temperature of the pickling liquid is high and the pickling period is long, the internal oxidized layer tends to be melted to become thin. Conversely, when the concentration or the temperature of the pickling liquid is low and the pickling period is short, the mill scale layer is insufficiently removed by the pickling. Thus, when, e.g., hydrochloric acid is used, it is recommended to set the concentration, the temperature and the period to about 3 to 20%, 60 to 90° C., and about 35 to 200 seconds, respectively.

The number of pickling baths used in the pickling is not particularly limited. Plural pickling baths may be used. It is allowable to add, to the pickling liquid, for example, an amine or any other pickling restrainer, i.e., an inhibitor, or a pickling promoter.

After the pickling, the steel sheet is cold-rolled to cause the internal oxidized layer with an average depth d of 4 μm or more. About conditions for the cold rolling, the cold roll reduction is preferably controlled into the range of 20 to 70%.

Next, the steel sheet is oxidized and reduced.

In detail, in an oxidizing zone, the steel sheet is initially oxidized at an air ratio of 0.9 to 1.4. The air ratio is the ratio of the amount of actually supplied air to the amount of air which is theoretically necessary for combusting a supplied combustion gas perfectly. In working examples that will be described later, CO gas is used. When the air ratio is higher than 1, the atmosphere turns into an oxygen-excessive state. When the air ratio is lower than 1, the atmosphere turns into an oxygen-short state.

By oxidizing the steel sheet in an atmosphere having an air ratio in the above-mentioned range, the decarbonization of this sheet is promoted. Consequently, a desired soft layer is formed to improve the steel sheet in bendability. Moreover, a Fe oxidized film can be produced on the surface to restrain the production of a composite oxidized film as described above, which is harmful against galvanizability, and others. If the air ratio is less than 0.9, the decarbonization becomes insufficient so that a sufficient soft layer is not formed to deteriorate the steel sheet in bendability. Moreover, the Fe oxidized film is not sufficiently produced so that the production of the composite oxidized film and the others cannot be produced to deteriorate the steel sheet in galvanizability. The air ratio is controlled indispensably to 0.9 or more, and preferably to 1.0 or more. If the air ratio is higher than 1.4, the Fe oxidized film is excessively produced, and in the next step, in a reducing furnace the steel sheet is not sufficiently reduced to hinder the galvanizability. The air ratio is controlled indispensably to 1.4 or less, and preferably to 1.2 or less.

In the oxidizing zone, it is especially important to control the air ratio, and conditions other than the ratio may be ordinarily used conditions. For example, the lower limit of the oxidizing temperature is preferably 500° C. or higher, more preferably 750° C. or higher. The upper limit of the oxidizing temperature is preferably 900° C. or lower, more preferably 850° C. or lower.

Next, in a reducing zone, the Fe oxidized film is reduced in a hydrogen atmosphere. In order to yield a desired hard layer in the present invention, the steel sheet needs to be heated in the austenite single phase region. The steel sheet is soaked in a temperature range not lower than the A_{c3} point. If the soaking temperature is lower than the A_{c3} point, polygonal ferrite is excessively produced. The soaking temperature is preferably not lower than the “A_{c3} point+15° C.”. The upper limit of the soaking temperature is not particularly limited and is, for example, 1000° C. or lower.

In the present invention, the A_{c3} point is calculated out on the basis of an expression (i) described below. In the expression, each [ ] represents the content (% by mass) of an element therein. In any one of its members that is related to a non-contained element, 0 (zero) is substituted thereinto to make a calculation. This expression is described in “The Physical Metallurgy of Steels, Leslie” (published by Maruzen Co., Ltd., William C. Leslie, p. 273).

A_{c3}(° C.)=910−203×[C]^{1/2}−15.2×[Ni]+44.7×[Si]+104×[V]+31.5×[Mo]+13.1×[W]−{30×[Mn]+11×[Cr]+20×[Cu]−700×[P]−400×[Al]−120×[As]−400×[T]} (i)

In the reducing furnace, it is especially important to control the soaking temperature, and conditions other than the temperature may be ordinarily used conditions.

It is preferred for the atmosphere in the reducing zone to be caused to contain hydrogen and nitrogen and have a hydrogen concentration controlled into the range of about 5 to 25% by volume.

The dew point thereof is preferably controlled into, for example, −30 to −60° C.

The retention period in the soaking treatment is not particularly limited, and is preferably controlled into, for example, about 10 to 100 seconds, particularly, about 10 to 80 seconds.

After the soaking, made are operations of cooling the steel sheet down to any stopping temperature Z satisfying a temperature from 100 to 540° C., and cooling the steel sheet in a temperature range from 750° C. to a higher temperature of the stopping temperature Z or 500° C. at an average cooling rate of 10° C./second or more, and retaining the steel sheet in the above-mentioned temperature range of 100 to 540° C. for 50 seconds or longer.

By the control of the average cooling rate in this temperature range, the production of polygonal ferrite can be restrained so that the produced amount of a low-temperature-transformation produced phase can be ensured. The average cooling rate in the temperature range is controlled indispensably into 10° C./second or more, and preferably into 20° C./second or more. The upper limit of the average cooling rate is not particularly limited. Considering the easiness of the control of the base steel sheet temperature, facility costs, and others, the upper limit is preferably about 100° C./second or less. The average cooling rate is more preferably 50° C./second or less, even more preferably 30° C./second or less.

After cooled to any stopping temperature Z satisfying a temperature from 100 to 540° C., the steel sheet is retained in the temperature range of 100 to 540° C. for 50 seconds or longer. The retention in this temperature range for 50 seconds or longer makes it possible to produce the above-mentioned low-temperature-transformation produced phase. The retention period in the temperature range is preferably 60 seconds or longer, more preferably 70 seconds or longer. The upper limit of the retention period in the temperature range is not particularly limited, and is, for example, preferably 1500 seconds or shorter, more preferably 1400 seconds or shorter, even more preferably 1300 seconds or shorter.

At the time of cooling the steel sheet down to the stopping temperature Z, which satisfies a temperature from 100 to 540° C., and retaining the steel sheet in this temperature range from 100 to 540° C., specific conditions are not particularly limited. The steel sheet may be retained in a constant temperature of the stopping temperature Z, or may be retained in constant temperatures in this temperature range to divide the retention temperature into two or more different stages. It is also allowable to cool the steel sheet rapidly to the stopping temperature Z, changing the cooling rate, and cool the steel sheet in this temperature range over a predetermined period or heat the steel sheet in this temperature range over a predetermined period. In this temperature range, cooling and heating may be appropriately repeated. It is also allowable to multi-stage-cool the steel sheet at two or more stages in which the cooling rates are different from each other, or multi-stage-heat the steel sheet at two or more stages in which the heating rates are different from each other.

As described in the case (C6-1), in order to produce a base steel sheet in which the low-temperature-transformation produced phase includes high-temperature-range produced bainite, the proportion of the high-temperature-range produced bainite is more than 50% by area and 95% or less by area of the whole of the metallic structure, the low-temperature-transformation produced phase may include low-temperature-range produced bainite and tempered martensite, and the proportion of the total of the low-temperature-range produced bainite and the tempered martensite is 0% or more by area and less than 20% by area of the whole of the metallic structure, it is preferred that the producing method satisfies the following requirement (a1) after the soaking:

The requirement (a1) is a requirement of cooling the steel sheet down to any stopping temperature Zₐ₁ satisfying a temperature from 420 to 500° C. both inclusive, and cooling the steel sheet at an average cooling rate of 10° C./second or more in a temperature range from 750° C. to 500° C. and retaining the steel sheet in this temperature range of 420 to 500° C. for 50 seconds or longer.

By setting the cooling stopping temperature Zₐ₁ to 420 to 500° C. both inclusive, and retaining the steel sheet in this temperature range for 50 seconds or longer, the high-temperature-range produced bainite, out of low-temperature-transformation produced phase species, can be mainly produced. The lower limit of the cooling stopping temperature is more preferably 430° C. or higher. The upper limit of the cooling stopping temperature is more preferably 480° C. or lower, even more preferably 460° C. or lower.

The retention period in the above-mentioned temperature range is more preferably 70 seconds or longer, even more preferably 100 seconds or longer, in particular preferably 200 seconds or longer. The upper limit of the retention period in the temperature range is not particularly limited, and is, for example, preferably 1500 seconds or shorter, more preferably 1400 seconds or shorter, even more preferably 1300 seconds or shorter.

By the control of this average cooling rate, the production of polygonal ferrite can be restrained and the production of high-temperature-range produced bainite can be promoted.

The average cooling rate in the temperature range is controlled preferably to 10° C./second or more, more preferably to 20° C./second or more. The upper limit of the average cooling rate is not particularly limited. Considering the easiness of the control of the base steel sheet temperature, facility costs and others, the upper limit is controlled preferably into about 100° C./second or less. The average cooling rate is more preferably 50° C./second or less, even more preferably 30° C./second or less.

As described in the case (C6-2), in order to produce a base steel sheet in which the low-temperature-transformation produced phase includes high-temperature-range produced bainite, low-temperature-range produced bainite and tempered martensite, the proportion of the high-temperature-range produced bainite is from 20 to 80% by area of the whole of the metallic structure, and the proportion of the total of the low-temperature-range produced bainite and the tempered martensite from 20 to 80% by area of the whole of the metallic structure, it is preferred that the producing method satisfies any one of the following requirement (a2), (b) and (C1) after the soaking:

The requirement (a2) is a requirement of cooling the steel sheet down to any stopping temperature Z₂ satisfying a temperature not lower than 380° C. and lower than 420° C., and cooling the steel sheet at an average cooling rate of 10° C./second or more in a temperature range from 750° C. to 500° C. and retaining the steel sheet in a temperature range not lower than 380° C. and lower than 420° C. for 50 seconds or longer.

By adjusting the cooling stop temperature Zₐ₂ to 380° C. or higher and lower than 420° C., and retaining the steel sheet in this temperature range for 50 seconds or longer, high-temperature-range produced bainite, low-temperature-range produced bainite, and tempered martensite can be produced as a low-temperature-transformation produced phase. In other words, by retaining the steel sheet at temperatures near 400° C., these structures are dispersed to set the interval between the above-mentioned retained γ grains, between the above-mentioned carbide grains, or between the above-mentioned γ grains and carbide grains to approximately 1 μm. The retained γ grains, and the carbide grains are precipitated in the form of not spheres but lumps like pillows. Thus, in an observed cross section thereof, respective directions of the retained γ grains and the carbide grains are not constant. Accordingly, in the case of measuring the interval between the retained γ grains, between the carbide grains, or between the γ grains and carbide grains, these grains are in a state that the high-temperature-range produced bainite, in which the average interval is 1 μm or more, and the low-temperature-range produced bainite, in which the average interval is less than 1 μm, are mixed with each other. The lower limit of the above-mentioned cooling stopping temperature is more preferably 390° C. or higher. The upper limit of the cooling stopping temperature is more preferably 410° C. or lower.

The retention period in the above-mentioned temperature range is more preferably 70 seconds or longer, more preferably 100 seconds or longer, in particular preferably 200 seconds or longer. The upper limit of the retention period in the temperature range is not particularly limited, and is, for example, preferably 1500 seconds or shorter, more preferably 1400 seconds or shorter, even more preferably 1300 seconds or shorter.

The requirement (b) is a requirement of cooling the steel sheet down to any stopping temperature Z_{b} satisfying an expression (1) described below, and cooling the steel sheet at an average cooling rate of 10° C./second or more in a temperature range from 750° C. to a higher temperature of the stopping temperature Z_{b} or 500° C., retaining the steel sheet in a temperature range T1 satisfying the expression (1) described below for 10 to 100 seconds, next cooling the steel sheet into a temperature range T2 satisfying the following expression (2) and retaining the steel sheet in this temperature range T2 for 50 seconds or longer:

400≦T1(° C.)≦540 (1) and

200≦T2(° C.)<400 (2).

It is allowable that after the steel sheet is cooled to any temperature Z_{b} satisfying the expression (1), the steel sheet is retained in the T1 temperature range for 10 to 100 seconds, and then retained in the temperature range T2 satisfying the expression (2) for 50 seconds or longer. By controlling the respective periods for retaining the steel sheet in the T1 temperature range and the T2 temperature range appropriately, high-temperature-range produced bainite, low-temperature-range produced bainite and others can be produced in respective predetermined amounts. Specifically, by retaining the steel sheet in the T1 temperature range for a predetermined period, the produced amount of high-temperature-range produced bainite is controllable. By the austempering treatment, in which the steel sheet is retained in the T2 temperature range for a predetermined period, non-transformed austenite can be transformed to low-temperature-range produced bainite or martensite, and further carbon can be concentrated into austenite to produce retained γ. In this way, the metallic structure specified in the present invention can be produced.

By combining the retaining in the T1 temperature range with the retaining in the T2 temperature range, the advantageous effect is exhibited that the production of an MA mixed phase can be restrained. A mechanism therefor would be as follows: in general, the addition of Si or A to steel causes the precipitation of any carbide so that free carbon atoms come to be present in the steel; according to austempering treatment, a phenomenon that non-transformed austenite is concentrated is recognized together with bainite transformation; and when carbon is concentrated into non-transformed austenite, retained γ can be produced in a large amount.

Herein, a description is made about the phenomenon that carbon is concentrated into the non-transformed austenite. The concentrated amount of carbon is restricted to a concentration represented by a To line along which the free energy of polygonal ferrite is equal to that of austenite. Thus, it is known that bainite transformation is also stopped in the line. Strictly, bainite transformation is stopped at a concentration deviated slightly from the To line. This To line is shifted toward a lower concentration of carbon as the temperature is higher. Thus, when austempering treatment is conducted at a relatively high temperature, bainite transformation is unfavorably stopped to some low degree even when the treating period is made long. In this case, non-transformed bainite is lower in stability so that coarse MA mixed phase grains are produced.

Thus, in the present invention, by retaining the steel sheet in the T1 temperature range and then retaining the steel sheet in the T2 temperature range, a permissible amount of the C concentration into non-transformed bainite can be made large, so that bainite transformation advances further in a low temperature range than in a high temperature range. Thus, the MA mixed phase grains become small. Moreover, in the case of retaining the steel sheet in the T2 temperature range compared with the case of retaining the steel sheet in the T1 temperature range, the size of lath-form microstructure becomes smaller. Consequently, even when the MA mixed phase is present, the MA mixed phase grains themselves can also be made into fine grains to be made small in size. Furthermore, the steel sheet is retained in the T1 temperature range for a predetermined period, and subsequently retained in the T2 temperature range; therefore, when the retaining in the T2 temperature range is started, high-temperature-range produced bainite has been already produced. Accordingly, in the T2 temperature range, the high-temperature-range produced bainite functions as a trigger to promote the transformation of low-temperature-range produced bainite. Thus, the advantageous effect is also exhibited that the austempering treatment period can be shortened.

In the present invention, the T1 temperature range specified by the expression (1) is specifically set to 400 to 540° C. both inclusive. By retaining the steel sheet in this TI temperature range for a predetermined period, high-temperature-range produced bainite can be produced. In other words, when the steel sheet is retained in a temperature range higher than 540° C., the production of high-temperature-range produced bainite is restrained while polygonal ferrite is excessively produced and further pseudo-perlite is produced. Consequently, the resultant steel sheet cannot gain desired properties. Thus, the upper limit of the T1 temperature range is preferably 540° C. or lower, more preferably 520° C. or lower, even more preferably 500° C. or lower. If the retention temperature is lower than 400° C., no high-temperature-range produced bainite is produced so that the steel sheet is lowered in elongation to fail to be improved in formability. Thus, the lower limit of the T1 temperature range is preferably 400° C. or higher, more preferably 420° C. or higher.

The period for retaining the steel sheet in the T1 temperature range is preferably from 10 to 100 seconds. If the retention period is longer than 100 seconds, the high-temperature-range produced bainite is excessively produced. Thus, as will be described later, even when the steel sheet is retained in the T2 temperature range for a predetermined period, the produced amount of low-temperature-range produced bainite cannot be ensured. Thus, the steel sheet cannot attain compatibility between strength and formability. If the steel sheet is retained in the T1 temperature range for a long period, carbon is excessively concentrated into austenite. Thus, even when the steel sheet is austempered in the T2 temperature range, coarse MA mixed phase grains are produced so that the formability is lowered. Thus, the retention period is set to 100 seconds or shorter, preferably to 90 seconds or shorter, more preferably 80 seconds or shorter. However, if the retention period in the T1 temperature range is too short, the produced amount of high-temperature-range produced bainite is decreased. Accordingly, the steel sheet is lowered in elongation to fail to be improved in formability. Thus, the retention period in the T1 temperature range is set to 10 seconds or longer, preferably to 15 seconds or longer, more preferably 20 seconds or longer, even more preferably 30 seconds or longer.

In the present invention, the retention period in the T1 temperature range means a period from the time when the surface temperature of the steel sheet reaches the upper limit temperature of the T1 temperature range to the time when the surface temperature reaches the lower limit temperature of the T1 temperature range.

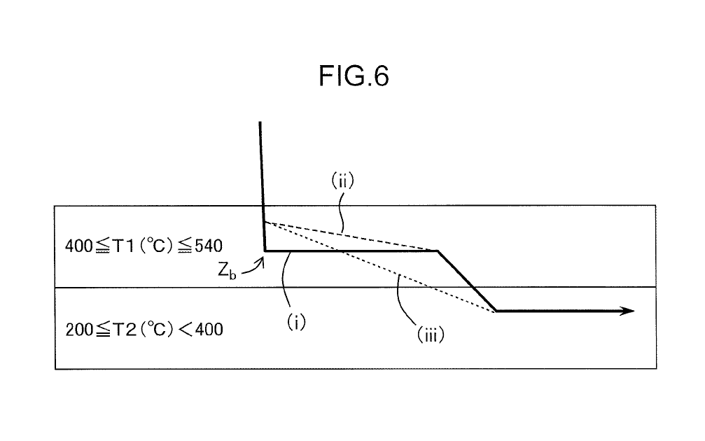

In order to keep the steel sheet in the T1 temperature range satisfying the expression (1), it is advisable to adopt, for example, heat patterns shown by lines (i) to (iii) in FIG. 6.

FIG. 6, line (i) is an example of cooling, after the soaking, the steel sheet rapidly to any temperature Z_{b} satisfying the expression (1), and subsequently retaining the steel sheet at this temperature Z_{b}, which is a constant temperature, for a predetermined period. After the homothermal retaining, the steel sheet is cooled to any temperature satisfying the expression (2). FIG. 6, line (i) shows a case of homothermal retaining at a single stage. However, the heat pattern is not limited to this example. Thus, homothermal retaining at two or more stages may be performed in which retention temperatures are different from each other as far as the temperatures are in the T1 temperature range.

FIG. 6, line (ii) is an example of cooling, after the soaking, the steel sheet rapidly to any temperature Z_{b} satisfying the T1 temperature range, changing the cooling rate, cooling the steel sheet into the T1 temperature range for a predetermined period, changing the cooling rate again, and cooling the steel sheet to any temperature satisfying the expression (2). FIG. 6, line (ii) shows a case of cooling the steel sheet in the T1 temperature range for a predetermined period. However, in the present invention, the heat pattern is not limited to this example. Thus, the heat pattern may include a step of heating the steel sheet for a predetermined period as far as the heating temperature is in the T1 temperature range. Cooling and heating may be appropriately repeated. It is also allowable to perform not single-stage-cooling as shown by FIG. 6, line (ii), but multi-stage-cooling in which cooling rates are different from each other, or allowable to perform single-stage-heating, or multi-stage-heating of two or more stages (not illustrated).

FIG. 6, line (iii) is an example of cooling, after the soaking, the steel sheet to any temperature Z_{b} satisfying the expression (1), changing the cooling rate, and cooling the steel sheet slowly at the same cooling rate to any temperature satisfying the expression (2). Even in the case of such a slow cooling, it is sufficient for the heat pattern to have a retention period of 10 to 100 seconds in the T1 temperature range.

In the present invention, the heat pattern thereof is not limited to any one of the heat patterns shown as lines (i) to (iii) in FIG. 6. Thus, any heat pattern other than these patterns may be appropriately adopted as far as the adopted heat pattern satisfies the requirements of the present invention.

In the present invention, specifically, the T2 temperature range satisfying the expression (2) is set preferably to 200° C. or higher and lower than 400° C. When the steel sheet is retained in this temperature range for a predetermined period, the non-transformed austenite that has not been transformed in the T1 temperature range can be transformed into low-temperature-range produced bainite or martensite. Moreover, when the retention period is sufficiently ensured, bainite transformation advances so that finally retained γ is produced and the MA mixed phase is also made into fine grains. Immediately after the transformation, the martensite is present as quenched martensite. However, while the steel sheet is retained in the T2 temperature range, the quenched martensite is tempered. As a result, the steel sheet remains as tempered martensite. The tempered martensite shows the same properties as the low-temperature-range produced bainite produced in the temperature range in which the martensitic transformation is caused. However, when the steel sheet is retained at 400° C. or higher, coarse MA mixed phase grains are produced so that the steel sheet is lowered in elongation and local deformabilities to fail to be improved in formability. Thus, the T2 temperature range is preferably lower than 400° C., more preferably 390° C. or lower, even more preferably 380° C. or lower. If the steel sheet is retained at a temperature lower than 200° C., no low-temperature-range produced bainite is produced so that the carbon concentration in the austenite is lowered. Accordingly, a retained γ amount cannot be ensured, and further quenched martensite is produced in a large amount so that the steel sheet is heightened in strength and deteriorated in elongation and localized deformabilities. Furthermore, the carbon concentration in the austenite is lowered so that the steel sheet cannot ensure a retained γ amount. Thus, the elongation cannot be heightened. Thus, the lower limit of the T2 temperature range is preferably 200° C. or higher, more preferably 250° C. or higher, even more preferably 280° C. or higher.

The period for retaining the steel sheet in the T2 temperature range satisfying the expression (2) is set preferably to 50 seconds or longer. If the retention period is shorter than 50 seconds, the produced amount of low-temperature-range produced bainite and others is decreased so that the steel sheet is lowered in carbon concentration in its austenite to fail to ensure a retained γ amount. Furthermore, quenched martensite is produced in a large amount so that the steel sheet is heightened in strength and deteriorated in elongation and localized deformabilities. Moreover, the concentrating of carbon is not promoted so that the steel sheet is decreased in retained γ amount to fail to be improved in elongation. Furthermore, the MA mixed phase produced in the T1 temperature range cannot be made into fine grains, so that the localized deformabilities cannot be improved. Thus, the retention period is set preferably to 50 seconds or longer, more preferably to 70 seconds or longer, even more preferably to 100 seconds or longer, in particular preferably 200 seconds or longer. The upper limit of the retention period is not particularly limited. However, if the steel sheet is retained for a long period, the productivity of such steel sheets is lowered, and further concentrated carbon is precipitated as a carbide so that retained γ cannot be produced. Consequently, the steel sheet is lowered in elongation and deteriorated in formability. Thus, it is advisable to set the upper limit of the retention period to, for example, 1800 seconds or shorter.

In the present invention, the retention period in the T2 temperature range means a period from the time when the surface temperature of the steel sheet reaches the upper limit temperature of the T2 temperature range to the time when the surface temperature reaches the lower limit temperature of the T2 temperature range.

The method for retaining the steel sheet in the T2 temperature range is not particularly limited as far as the method renders the staying period in the T2 temperature range a period of 50 seconds or longer. The steel sheet may be retained at a constant temperature as in the heat patterns shown in FIG. 6 in the T1 temperature range, or may be cooled or heated in the T2 temperature range. Moreover, the steel sheet may be retained at plural stages different from each other in retaining temperature.

The requirement (c1) is a requirement of cooling the steel sheet down to any stopping temperature Z_{c1} satisfying an expression (3) described below or the Ms point, and cooling the steel sheet at an average cooling rate of 10° C./second or more in a temperature range from 750° C. to 500° C., retaining the steel sheet in a temperature range T3 satisfying the expression (3) described below for 5 to 180 seconds, next heating the steel sheet into a temperature range T4 satisfying the following expression (4) and retaining the steel sheet in this temperature range T4 for 30 seconds or longer:

100≦T3(° C.)<400 (3) and

400≦T4(° C.)≦500 (4).

The Ms point is calculated out on the basis of an expression (ii) described below. In the expression, each [ ] represents the content (% by mass) of an element therein. About any one of its members that is related to a non-contained element, 0 (zero) is substituted thereinto to make a calculation. This expression is described in “The Physical Metallurgy of Steels, Leslie” (published by Maruzen Co., Ltd., William C. Leslie, p. 231).

Ms(° C.)=561−474×[C]−33×[Mn]−17×[Ni]−17×[Cr]−21×[Mo] (ii)

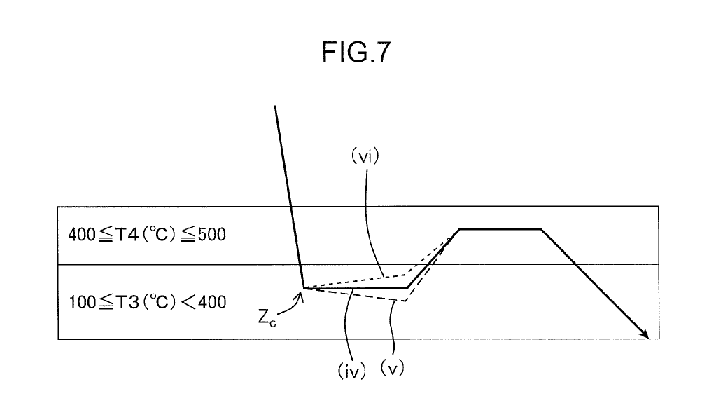

As shown in FIG. 7, after the soaking, it is preferred to cool the steel sheet rapidly to any temperature Z_{c1} satisfying the expression (3) or the Ms point in an average cooling rate of 10° C./second or more. By cooling the steel sheet rapidly in a range from the temperature range not lower than the A_{c3} point to any temperature Z_{c1} satisfying the expression (3) or the Ms point, austenite can be restrained from being transformed to polygonal ferrite, and low-temperature-range produced bainite or martensite can be produced in a predetermined amount. The average cooling rate in this section is more preferably 15° C./second or more. The upper limit of the average cooling rate is not particularly limited, and is sufficient to be, for example, about 100° C./second.

After the steel sheet is cooled to any temperature Z_{c1} satisfying the expression (3) or the Ms point, as shown in FIG. 7 the steel sheet is retained in the T3 temperature range satisfying the expression (3) for 5 to 180 seconds, and subsequently the steel sheet is heated to the T4 temperature range satisfying the expression (4) and retained in this T4 temperature range for 30 seconds or longer.

In the present invention, the retention period in the T3 temperature range means that a period from the time when the steel sheet is soaked at a temperature not lower than the A_{c3} point and subsequently the surface temperature of the steel sheet turns below 400° C. to the time when the steel sheet is retained in the T3 temperature range and subsequently started to be heated so that the surface temperature of the steel sheet reaches 400° C. In the invention, therefore, the steel sheet comes to be again passed through the T3 temperature range since the steel sheet is retained in a T4 temperature range and then cooled to room temperature, which will be described later. In the invention, this passing period at the time of the cooling is not caused to be included in the staying period in the T3 temperature range. This is because at this cooling time, the transformation of the steel sheet has been substantially completed so that no low-temperature-range produced bainite is produced.

The retention period in the T4 temperature range means a period from the time when the steel sheet is heated after retained in the T3 temperature range so that the surface temperature of the steel sheet becomes 400° C. to the time when the surface temperature of the steel sheet reaches 400° C. by starting to cool the steel sheet after the steel sheet is retained in the T4 temperature range. As described above, therefore, in the present invention, after the soaking, the steel sheet passes in the T4 temperature range in the middle of cooling the steel sheet into the T3 temperature range. In the present invention, the staying period in the T4 temperature range does not include this passing period at the time of the cooling. This is because at this cooling time, the staying period is too short so that the steel sheet is hardly transformed and thus no high-temperature-range produced bainite is produced.

In the present invention, high-temperature-range produced bainite can be produced in a predetermined amount by controlling appropriately respective periods when the steel sheet is retained in the T3 temperature range and in the T4 temperature range. Specifically, by retaining the steel sheet in the T3 temperature range for a predetermined period, non-transformed austenite is transformed to low-temperature-range produced bainite, bainitic ferrite, or martensite. By retaining the steel sheet in the T4 temperature range for a predetermined period to conduct austempering treatment, the non-transformed austenite is further transformed to high-temperature-range produced bainite, and bainitic ferrite. The produced amounts thereof are controlled and further carbon is concentrated to the austenite to produce retained γ. In this way, metallic structure specified in the present invention can be produced.

Moreover, by retaining the steel sheet in the T3 temperature range and then retaining the steel sheet in the T4 temperature range, an effect of making the MA mixed phase into fine grains is also exhibited. In other words, the steel sheet is soaked at a temperature not lower than the A_{c3} point, and then rapidly cooled at an average cooling rate of 10° C./second or more in any temperature Z_{c1} in the T3 temperature range, or the Ms; and subsequently the steel sheet is retained in this T3 temperature range, thereby producing martensite or low-temperature-range produced bainite; thus, the non-transformed portions are made into fine grains, and further the concentrating of carbon into the non-transformed portions is also restrained to an appropriate degree so that the MA mixed phase is made into fine grains.

In the present invention, specifically, the T3 temperature range specified by the expression (3) is set preferably to 100° C. or higher and lower than 400° C. By retaining the steel sheet in this temperature range for a predetermined period, the non-transformed austenite can be transformed to low-temperature-range produced bainite, bainitic ferrite, or martensite. Moreover, by ensuring the retention period sufficiently, the bainite transformation is advanced so that retained γ is finally produced and the MA mixed phase is also made into fine grains. Immediately after the transformation, the martensite is present as quenched martensite. However, while the steel sheet is retained in the T4 temperature range, which will be described later, the martensite is tempered to remain as tempered martensite. The tempered martensite does not affect the elongation, the hole expandability or bendability of the steel sheet. However, if the steel sheet is retained at 400° C. or higher, neither low-temperature-range produced bainite nor martensite is produced so that the bainite structure cannot be made composite. Furthermore, coarse MA mixed phase grains are produced so that the MA mixed phase cannot be made into fine grains. Consequently, the steel sheet is lowered in localized deformabilities to fail to be improved in bendability or hole expandability. Thus, the T3 temperature range is set preferably to lower than 400° C. The T3 temperature range is more preferably 390° C. or lower, even more preferably 380° C. or lower. In the meantime, even when the steel sheet is retained at a temperature lower than 100° C., the martensite fraction becomes too large so that the steel sheet is deteriorated in formabilities. Furthermore, low-temperature-range produced bainite is produced even when the steel sheet is retained at a temperature lower than 100° C. However, as described above, the martensite fraction becomes too large so that the fraction of the low-temperature-range produced bainite analogs is increased, so that the steel sheet is deteriorated in formabilities. Thus, the lower limit of the T3 temperature range is set preferably to 100° C. or higher. The T3 temperature range is more preferably 110° C. or higher, even more preferably 120° C. or higher.

The period for retaining the steel sheet in the T3 temperature range satisfying the expression (3) is preferably from 5 to 180 seconds. If the retention period is lower than 5 seconds, the produced amount of low-temperature-range produced bainite is reduced so that the bainite structure cannot be made composite and the MA mixed phase is not made into fine grains. Thus, the steel sheet is lowered in hole expandability, bendability and others. Thus, the retention period is set preferably to 5 seconds or longer, more preferably to 10 seconds or longer, even more preferably to 20 seconds or longer, in particular preferably to 40 seconds or longer. However, if the retention period is longer than 180 seconds, low-temperature-range produced bainite tends to be excessively produced. Thus, as will be described later, even when the steel sheet is retained in the T4 temperature range for a long period, the produced amount of high-temperature-range produced bainite and others cannot be easily ensured so that the steel sheet is lowered in elongation. Thus, the retention period is set preferably to 180 seconds or shorter, more preferably to 150 seconds or shorter, even more preferably to 120 seconds or shorter, in particular preferably to 80 seconds or shorter.

The method for retaining the steel sheet in the T3 temperature range satisfying the expression (3) is not particularly limited as far as the method causes the staying period in the T3 temperature range to fall in the above-mentioned range. It is advisable to adopt, for example, heat patterns shown by lines (iv) to (vi) in FIG. 7. However, in the present invention, the heat pattern thereof is not limited these heat patterns. Thus, heat patterns other than these heat patterns may be appropriately adopted as far as the heat patterns each satisfy the requirements of the present invention.

FIG. 7, line (iv) is an example of cooling the steel sheet rapidly from a temperature not lower than the A_{c3} point to any temperature Z_{c1} satisfying the expression (3), and subsequently retaining the steel sheet at this temperature Z_{c1}, which is a constant temperature, for a predetermined period. After the homothermal retaining, the steel sheet is cooled to any temperature satisfying the expression (4). FIG. 7, line (iv) shows a case of performing homothermal retaining at a single stage. However, in the present invention, the heat pattern is not limited to this example. Thus, homothermal retaining at two or more stages may be performed in which retention temperatures are different from each other as far as the temperatures are in the T3 temperature range (not illustrated).

FIG. 7, line (v) is an example of cooling the steel sheet rapidly from a temperature not lower than the A_{c3} point to any temperature Z_{c1} satisfying the formula (3), changing the cooling rate, cooling the steel sheet in the T3 temperature range for a predetermined period, and heating the steel sheet to any temperature satisfying the expression (4). FIG. 7, line (v) shows a case of cooling the steel sheet at a single stage. However, in the present invention, the heat pattern thereof is not limited to this example. Thus, multi-stage-cooling may be performed at two or more stages different from each other in cooling rate (not illustrated).

FIG. 7, line (vi) is an example of cooling the steel sheet rapidly from a temperature not lower than the A_{c3} point to any temperature Z_{c1} satisfying the expression (3), heating the steel sheet in the T3 temperature range for a predetermined period to heat the steel sheet to any temperature satisfying the expression (4). FIG. 7, line (vi) shows a case of performing heating at a single stage. However, in the present invention, the heat pattern thereof is not limited to this example. Thus, multi-stage-heating may be performed at two or more stages different from each other in heating rate (not illustrated).

In the present invention, the T4 temperature range specified in the expression (4) is specifically set preferably to 400 to 500° C. both inclusive. By retaining the steel sheet in this temperature range for a predetermined period, high-temperature-range produced bainite and bainitic ferrite can be produced. In other words, when the steel sheet is retained in a temperature range higher than 500° C., soft polygonal ferrite, pseudo-perlite, and others are present in an amount larger than a predetermined amount so that the steel sheet cannot gain desired properties. Thus, the upper limit of the T4 temperature range is set preferably to 500° C. or lower, more preferably to 490° C. or lower, even more preferably to 480° C. or lower. If the retention temperature in the T4 temperature range is lower than 400° C., no high-temperature-range produced bainite is produced so that the steel sheet is lowered in elongation. Thus, the lower limit of the T4 temperature range is set preferably to 400° C. or higher, more preferably to 420° C. or higher, even more preferably to 425° C. or higher.

A period when the steel sheet is retained in the T4 temperature range satisfying the expression (4) is set preferably to 30 seconds or longer. According to the present invention, even when the retention period in the T4 temperature range is set to about 30 seconds, the steel sheet is beforehand retained in the T3 temperature range for a predetermined period to produce low-temperature-range produced bainite analogs. Thus, the low-temperature-range produced bainite analogs promotes the production of low-temperature-range produced bainite, so that the produced amount of the high-temperature-range produced bainite can be ensured. However, if the retention period is shorter than 30 seconds, non-transformed portions remain in a large amount and carbon is insufficiently concentrated, so that the steel sheet undergoes martensitic transformation when finally cooled from the T4 temperature range. Accordingly, a hard MA mixed phase is produced so that the steel sheet is lowered in bendability, hole expandability and others. In order to improve the productivity of such steel sheets, the retention period in the T4 temperature range is preferably made as short as possible. In order to produce high-temperature-range produced bainite certainly, the retention period is set preferably to 50 seconds or longer, more preferably to 100 seconds or longer, in particular preferably to 200 seconds or longer. When the steel sheet is retained in the T4 temperature range, the upper limit of the period is not particularly limited. The period is set preferably to 1800 seconds or shorter, more preferably 1500 seconds or shorter, even more preferably 1000 seconds or shorter since the production of the high-temperature-range produced bainite is saturated even when the steel sheet is retained for a long period, and further the productivity is lowered.

The method for retaining the steel sheet in the T4 temperature range satisfying the expression (4) is not particularly limited as far as the method renders the staying period in the T4 temperature range a period of 30 seconds or longer. As in the heat pattern in the T3 temperature range, the steel sheet may be retained at any constant temperature in the T4 temperature range, or may be cooled or heated in the T4 temperature range.

For reference, in the present invention, the steel sheet is retained in the T3 temperature range, which is a lower range, and then retained in the T4 temperature range, which is a higher range. The inventors have verified the following about the low-temperature-range produced bainite and others that are produced in the T3 temperature range: the steel sheet is heated to the T3 temperature range, and then its lower structure is recovered by tempering; however, the lath interval thereof, that is, the above-mentioned average interval does not change.

By the control of the average cooling rate in the requirements (a2), (b) and (c1), the production of polygonal ferrite can be restrained. As a result, the produced amount of high-temperature-range produced bainite, low-temperature-range produced bainite and tempered martensite can be ensured. The average cooling rate in the temperature range is controlled preferably to 10° C./second or more, more preferably 20° C./second or more. The upper limit of the average cooling rate in the temperature range is not particularly limited. Considering the easiness of the control of the base steel sheet temperature, facility costs and others, the upper limit is controlled preferably to about 100° C./second or lower. The average cooling rate is more preferably 50° C./second or lower, even more preferably 30° C./second or lower.

As in the case (C6-3), in order to produce a base steel sheet in which the low-temperature-transformation produced phase includes low-temperature-range produced bainite and tempered martensite, and the proportion of the total of the low-temperature-range produced bainite and the tempered martensite is more than 50% by area and 95% or less by area of the whole of the metallic structure, the low-temperature-transformation produced phase may include high-temperature-range produced bainite, and the proportion of the high-temperature-range produced bainite is 0% or more by area and less than 20% by area of the whole of the metallic structure, it is preferred to satisfy either the requirement (a3) or (c2) described below.

The requirement (a3) is a requirement of cooling the steel sheet down to any stopping temperature Zₐ₃ satisfying a temperature not lower than 150° C. and lower than 380° C., and cooling the steel sheet at an average cooling rate of 10° C./second or more in a temperature range from 750° C. to 500° C. and retaining the steel sheet in a temperature range not lower than 150° C. and lower than 380° C. for 50 seconds or longer.

By setting the cooling stopping temperature Zₐ₃ to 150° C. or higher and lower than 380° C. and retaining the steel sheet in this temperature range for 50 seconds or longer, and retaining the steel sheet in this temperature range, low-temperature-range produced bainite and tempered martensite, out of low-temperature-transformation produced phase species, can be mainly produced. The lower limit of the cooling stopping temperature is more preferably 170° C. or higher. The upper limit of the cooling stopping temperature is more preferably 370° C. or lower, even more preferably 350° C. or lower.

The retention period in the temperature range is more preferably 70 seconds or longer, even more preferably 100 seconds or longer, in particular preferably 200 seconds or longer.

The upper limit of the retention period in the temperature range is not particularly limited, and is, for example, preferably 1500 seconds or shorter, more preferably 1400 seconds or shorter, even more preferably 1300 seconds or shorter.

The requirement (c2) is a requirement of cooling the steel sheet down to any stopping temperature Z_{c2} satisfying an expression (3) described below, or the Ms point, and cooling the steel sheet at an average cooling rate of 10° C./second or more in a temperature range from 750° C. to 500° C., retaining the steel sheet in a temperature range T3 satisfying the expression (3) described below for 5 to 180 seconds, next heating the steel sheet into a temperature range T4 satisfying the following expression (4) and retaining the steel sheet in this temperature range T4 for 30 seconds or longer:

100≦T3(° C.)<400 (3) and

400≦T4(° C.)≦500 (4).

Conditions for the requirement (c2) are the same as for the requirement (c1). In order to produce low-temperature-range produced bainite or the like mainly, the cooling stopping temperature Z_{c2} is set into a relatively low temperature in the T3 temperature range to produce martensite in a large proportion, and this steel sheet is heated into the T4 temperature range to temper the martensite into tempered martensite provided that this fact depends on components of the steel sheet. As a result, the steel sheet comes to be made mainly of the low-temperature-range produced bainite or the like. In this case, by heating the steel sheet into the T4 temperature range, high-temperature-range produced bainite is also produced. However, the tempered martensite amount is increased so that the steel sheet comes to be made mainly of the low-temperature-range produced bainite or the like.

By the control of the average cooling rate in the requirement (a3) or (c2), the production of polygonal ferrite can be restrained. As a result, the produced amount of low-temperature-range produced bainite and tempered martensite can be ensured. The average cooling rate in this temperature range is controlled preferably to 10° C./second or more, more preferably to 20° C./second or more. The upper limit of the average cooling rate is not particularly limited. Considering the easiness of the control of the base steel sheet temperature, facility costs and others, the upper limit is controlled preferably to about 100° C./second or less. The average cooling rate is more preferably 50° C./second or less, more preferably 30° C./second or less.

Thereafter, the steel sheet is subjected to hot-dip galvanizing by an ordinary method. The method for the hot-dip galvanizing is not particularly limited. For example, the lower limit of the galvanizing bath temperature is preferably 400° C. or higher, more preferably 440° C. or higher. The upper limit of the galvanizing bath temperature is preferably 500° C. or lower, more preferably 470° C. or lower.

The composition of the hot-dip galvanizing bath is not particularly limited. It is sufficient to use a known hot-dip galvanizing bath.

Cooling conditions after the hot-dip galvanizing are not particularly limited, either. For example, the average cooling rate down to ambient temperature is controlled preferably to about 1° C./second or more, more preferably to 5° C./second or more. The upper limit of the average cooling rate is not particularly limited. Considering the easiness of the control of the base steel sheet temperature, facility costs, and others, the upper limit is controlled preferably to about 50° C./second or less. The average cooling rate is preferably 40° C./second or less, more preferably 30° C./second or less.

After the hot-dip galvanizing is performed, the steel sheet may be optionally subjected to alloying treatment by an ordinary method.

Conditions for the alloying treatment are not particularly limited, either. For example, it is preferred that under the above-mentioned conditions, the hot-dip galvanizing is performed, and subsequently the steel sheet is retained at about 500 to 600° C., particularly about 500 to 550° C. for about 5 to 30 seconds, particularly about 10 to 25 seconds. If the temperature and the period are lower than the respective ranges, the hot-dip galvanized layer is insufficiently alloyed. In the meantime, if these are higher than the respective ranges, a carbide is precipitated to decrease the retained austenite so that the steel sheet cannot gain desired properties. Furthermore, polygonal ferrite is also excessively produced with ease.

It is advisable to conduct the alloying treatment, using, for example, a heating furnace, direct fire, or an infrared heating furnace.

The heating means is not particularly limited, either, and may be, for example, a common means such as gas heating, or induction heater heating, i.e., a high frequency induction heating device.

After the alloying treatment, the steel sheet is cooled by an ordinary method to yield a hot-dip galvannealed steel sheet. The average cooling rate down to ambient temperature is controlled preferably to about 1° C./second or more. The upper limit of the average cooling rate down to ambient temperature is not particularly limited. Considering the easiness of the control of the base steel sheet temperature, facility costs, and others, the upper limit is controlled preferably to about 50° C./second or less.

[Second Producing Method (with Temperature Keeping)]

The second producing method according to the present invention includes the following steps in the order of the described steps: a hot-rolling step of coiling a steel sheet having the steel components of said base steel sheet at a temperature of 500° C. or higher; a step of keeping the temperature of the steel sheet in temperatures of 500° C. or higher for 60 minutes or longer; a step of pickling and cold-rolling the steel sheet such that there remain the internal oxidized layer with an average depth d of 4 μm or more; a step of oxidizing the steel sheet at an air ratio of 0.9 to 1.4 in an oxidizing zone; a step of soaking the steel sheet in a temperature range not lower than the A_{c3} point in a reducing zone; and a step of cooling, after the soaking, the steel sheet to any stopping temperature Z satisfying a temperature from 100 to 540° C., and cooling the steel sheet, in a temperature range from 750° C. to 500° C., at an average cooling rate of 10° C./second or more and retaining the steel sheet in the above-mentioned temperature range of 100 to 540° C. for 50 seconds or longer. As compared with the first producing method, the second producing method is different from the first producing method in only the following two points: the lower limit of the coiling temperature after the hot rolling is set to 500° C. or higher; and a temperature keeping step is added to the second producing method after the hot rolling step. Thus, hereinafter, only these different points will be described. About steps consistent with those in the first producing method, it is sufficient to refer to the first producing method.

The reason why the temperature keeping step is added to the method as described above is that the addition makes it possible to retain the steel sheet, in a temperature range in which the steel sheet can be oxidized by keeping the temperature thereof, for a long period so that the lower limit of a coiling temperature range in which a desired internal oxidized layer and soft layer can be obtained can be widened. Moreover, the addition also produces an advantage of decreasing a difference in temperature between each surface layer of the base steel sheet and the inside thereof to heighten the base steel sheet in uniformity.

In the second producing method, initially, after the hot rolling, the coiling temperature is controlled to 500° C. or higher. As will be detailed later, the temperature keeping step is arranged after the coiling. Thus, the coiling temperature can be made lower than 600° C., which is the lower limit of the coiling temperature in the first producing method. The coiling temperature is preferably 540° C. or higher, more preferably 570° C. or higher. A preferred upper limit of the coiling temperature is the same as in the first producing method, and is set preferably to 750° C. or lower.

Next, the temperature of the thus obtained hot-rolled steel sheet is kept in temperatures of 500° C. or higher for 60 minutes or longer. This step makes it possible to yield a desired internal oxidized layer. To exhibit the above-mentioned advantageous effects effectively by the temperature keeping, it is preferred to put the hot-rolled steel sheet into, for example, a thermally insulating instrument to keep the temperature thereof.

The instrument used in the present invention is not particularly limited as far as the instrument is made of a thermally insulating raw material. Such a raw material is preferably a ceramic fiber.

To exhibit the above-mentioned advantageous effects effectively, it is necessary to keep the temperature of the steel sheet in temperatures of 500° C. or higher for 60 minutes or longer. The sheet-temperature keeping temperature is preferably 540° C. or higher, more preferably 560° C. or higher. The sheet-temperature keeping period is preferably 100 minutes or longer, more preferably 120 minutes or longer. Considering pickling performance of the method, the productivity, and others, the respective upper limits of the temperature and the period are controlled preferably to about 700° C. or lower and about 500 minutes or shorter.

The above has described and the first and second producing methods.

The plated steel sheet of the present invention, which is obtained by the producing methods, may be subjected to various painting treatment and surface preparing treatments therefor, for example, chemical treatments such as phosphate treatment; or organic coat treatments, for example, organic coat formation such as film laminating.

The paint used for the various painting treatments may be a known resin, examples thereof including epoxy resin, fluororesin, silicone acrylic resin, polyurethane resin, acrylic resin, polyester resin, phenolic resin, alkyd resin and melamine resin. From the viewpoint of corrosion resistance, preferred are epoxy resin, fluororesin and silicone acrylic resin. Together with any one of these resins, a hardener may be used. The paint may contain a known additive, examples thereof including a coloring pigment, a coupling agent, a levelling agent, a sensitizer, an anti-oxidizer, an ultraviolet stabilizer, and a flame retardant.

In the present invention, the form of the paint is not particularly limited. A paint in any form is usable, examples thereof including a solvent based paint, a water based paint, an aqueous dispersion paint, a powder paint, and an electrodeposition paint.

The painting method is not particularly limited, and may be, for example, a dipping, roll coater, spraying, curtain flow coater, or electrodeposition coating method. About the galvanized layer or galvannealed layer, the organic coat, the chemically treated film, the paint coat, and other covering layers, it is sufficient for the respective thickness thereof to be appropriately set in accordance with the usage of the plated steel sheet.

The high-strength plated steel sheet of the present invention is high in strength and is further excellent in formabilities (elongation, bendability and hole expandability), and delayed fracture resistance. Accordingly, the steel sheet is usable for collision parts, such as a side member of a front or rear portion of a mobile machine and a crush box; pillars such as a center pillar reinforce; and vehicle body constituting parts such as a roof rail reinforce, a side sill, a floor member and a kicking member.

The present patent application claims priorities based on Japanese Patent Application No. 2015-3705 filed on Jan. 9, 2015, and Japanese Patent Application No. 2015-182115 filed on Sep. 15, 2015. The entire contents of the Descriptions of the Japanese Patent Application No. 2015-3705 and the Japanese Patent Application No. 2015-182115 are incorporated into the present application for reference.

### EXAMPLES

Hereinafter, the present invention will be more specifically described by way of working examples thereof. However, the invention is not limited by the examples. The examples may each be modified and carried out as far as the modified example is within a scope conforming to the above-mentioned subject matters of the invention and subjected matters thereof that will be described hereinafter. The modified examples are each included in the technical scope of the invention.

Each slab including components shown in Table 1 described below, the balance thereof being composed of iron and inevitable impurities, was heated to 1250° C., hot-rolled into 2.4 mm at a finish rolling temperature of 900° C., and then coiled at a coiling temperature in one of Tables 2 to 4 described below to produce a hot-rolled steel sheet. About Nos. 24 to 32, 35, 37 and 39 shown in Table 3, and Nos. 41, 43, 47, and 49-51 shown in Table 4, the coiled hot-rolled steel sheets were each put into a ceramic-fiber thermally insulting instrument to keep the temperature thereof. One of Tables 3 and 4 shows a period during which the temperature of the steel sheet was kept in temperatures of 500° C. or higher. The temperature keeping period was measured in the state of fitting a thermocouple to the outer circumference of the coil.

Next, the resultant hot-rolled steel sheet was pickled under conditions described below, and then cold-rolled at a cold roll reduction of 50%. The thickness of the cold-rolled sheet was 1.2 mm.

Picking solution: 10% hydrochloric acid, temperature: 82° C., and pickling period: as shown in one of Tables 2 to 4.

Next, the steel sheet was annealed (oxidized and reduced) and cooled under conditions shown in the one of Tables 2 to 4 in a continuous hot-dip galvanizing line. The temperature of an oxidizing furnace located in the continuous hot-dip galvanizing line was 800° C. In the one of Tables 2 to 4, the air ratio in the oxidizing furnace is shown. The hydrogen concentration in a reducing furnace located in the continuous hot-dip galvanizing line was set to 20% by volume. The balance of the gas was rendered nitrogen and inevitable impurities, and the dew point was controlled to −45° C. In the reducing furnace, the highest arrival temperature was set to a temperature shown in the one of Tables 2 to 4 to soak the steel sheet. The retention period at each of the highest arrival temperatures shown in Tables 2 to 4 was set to 50 seconds. In the one of Tables 2 to 4 are shown the temperature of the A_{c3} point temperature of the steel sheet, which was calculated out on the basis of its component composition shown in Table 1, and the expression (i).

After the soaking, the steel sheet was cooled to any stopping temperature Z satisfying a temperature from 100 to 540° C., and cooled in a temperature range from 750° C. to a higher temperature of the stopping temperature Z or 500° C. in an average cooling rate shown in the one of Tables 2 to 4. At this time, the steel sheet was retained for a period shown in the one of Tables 2 to 4. In this case, specifically, about each of Nos. 20, 25, 34, 44, 46 and 50, on the basis of a heat pattern shown in the above-mentioned requirement (a1), the cooling stopping temperature was determined; about each of Nos. 1, 2, 10, 21-23, 31, 33, 35, 36, and 42, on the basis of a heat pattern shown in the requirement (a2); about each of Nos. 13-15, 18, 24, 27, 32, 37, 45, 49 and 52, on the basis of a heat pattern shown in the requirement (a3); about each of Nos. 6, 9, 12, 17, 30 and 43, on the basis of a heat pattern shown in the requirement (b); about each of Nos. 3-5, 7, 8, 11, 16, 26, 28, 29, 41, 47, 48 and 51, on the basis of a heat pattern shown in the requirement (c1); and about No. 19, on the basis of a heat pattern shown in the requirement (c2). Furthermore, these samples were each retained after the cooling stop. The Ms point of each of the steel sheets was calculated out on the basis of one of the component compositions shown in Table 1, and the expression (ii). The individual Ms points are shown in Tables 2 to 4.

In the case of stopping the cooling, and subsequently retaining any one of the steel sheets at the stopping temperature, in one of Tables 2 to 4 the same temperature is shown in its cooling stopping temperature column, and its austempering temperature column. The period during which the steel sheet was retained at the cooling stopping temperature is shown in its austempering period column. In the case of stopping the cooling, and subsequently retaining any one of the steel sheets at the stopping temperature and then heating or cooling the steel sheet to change the temperature, the temperature after the change is shown in the austempering temperature column. The period during which the steel sheet was retained at the temperature after the change is shown in the austempering period column.

Thereafter, some of the steel sheets were each immersed in a hot-dip galvanizing bath of 460° C. temperature. After the immersion for 5 seconds, the steel sheet was cooled to room temperature at an average cooling rate of 5° C./second to yield a hot-dip galvanized steel sheet (GI). About hot-dip galvannealed steel sheets (GA), each of the remaining steel sheets was immersed in the hot-dip galvanizing bath to apply hot-dip galvanizing to the steel sheet. The steel sheet was then heated to 500° C. and retained at this temperature for 20 seconds to be subjected to alloying treatment. Thereafter, the steel sheet was cooled to room temperature at an average cooling rate of 10° C./second. About each of all the samples, a distinction into GI or GA is shown in one of Tables 2 to 4.

About the resultant hot-dip galvanized steel sheets (GI), and hot-dip galvannealed steel sheets (GA), properties described below were evaluated.

As described below, about the average depth of each of the internal oxidized layers, not only the depth in the plated steel sheet but also the depth in the base steel sheet after the pickling and the cold rolling was also measured in the same way for reference. This measurement was made to check whether or not a desired average of the internal oxidized layer was already grained, in the cold-rolled steel sheet before the annealing, by controlling the coiling temperature and pickling conditions after the hot rolling.

(1) Measurement of Average Depth d of Internal Oxidized Layer in Each of Plated Steel Sheets

From a portion of W/4 of the plated steel sheet wherein W represents the sheet width of the plated steel sheet, a test piece of 50 mm×50 mm size was collected, and then from the outer surface of the galvanized layer or galvannealed layer, the O amount, the Fe amount, and the Zn amount were analyzed and determined by glow discharge-optical emission spectroscopy (GD-OES). In detail, a GD-OES machine of GD-PROFILER 2 model GDA750 manufactured by Horiba, Ltd. was used to apply high frequency sputtering to a surface of the test piece inside an Ar glow discharge region. In the Ar plasm, an emission line of each of the O, Fe and Zn elements emitted by the sputtering was continuously subjected to spectral diffraction to measure a profile of the element amount in the depth direction of the base steel sheet. Conditions for the sputtering are as described below. The measuring region was from the outer surface of the galvanized layer or galvannealed layer to a depth of 50 μm.

### (Sputtering Conditions)

Pulse sputtering frequency: 50 Hz

Anode diameter (analyzing area): 6 mm in diameter

Electric discharge power: 30 W

Ar gas pressure: 2.5 hPa

The analyzed results are shown in FIG. 2. In FIG. 2, a position where the Zn amount is equal to the Fe amount in a region from the outer surface of a galvanized layer or galvannealed layer 1 is defined as an interface between the galvanized layer or galvannealed layer 1 and a base steel sheet 2.

The average value of the respective O amounts at individual measuring points from the outer surface of the galvanized layer or galvannealed layer 1 to a depth of 40 to 50 μm was defined as the O amount average of the bulk. A region of the steel sheet where the O amount was 0.02% higher than the average, that is, the O amount>“O amount average of bulk+0.02%” was defined as an internal oxidized layer 3. The maximum depth thereof was defined as the internal oxidized layer depth. The same test was made using three test pieces. The average of the resultant values was defined as the average depth d (μm) of the internal oxidized layer 3. The results are shown in Tables 5 to 7 described below.

(2) Measurement of Depth of Each Internal Oxidized Layer after Pickling and Cold Rolling (Reference)

Each of the pickled and cold-rolled base steel sheets was used. In the same way as in item (1) except the use, the average depth of its internal oxidized layer was calculated out. The calculated results are shown in Tables 2 to 4.

(3) Measurement of Average Depth D of Each Soft Layer

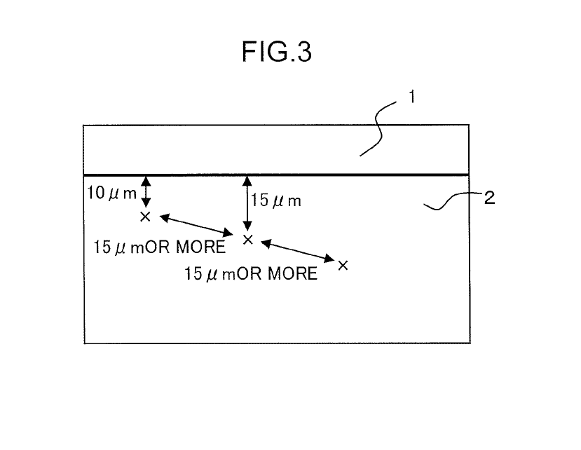

A portion of W/4 of each of the plated steel sheets, which was a cross section of the steel sheet that was perpendicular to the sheet-width-W direction of the sheet, was made naked, and therefrom a test piece of 20 mm×20 mm size was collected. The piece was then buried into a resin, and the Vickers hardness thereof was measured from the interface between the galvanized layer or galvannealed layer and the base steel sheet toward the inside of the base steel sheet along the sheet thickness “t”. The measurement was made using a Vickers hardness meter under a load of 3 gf. In detail, as shown in FIG. 3, the measurement was made at a pitch of 5 μm from a measuring point toward thickness inner portions of the steel sheet, this measuring point being a point of a sheet-thickness-inside depth of 10 μm from the interface between the galvanized layer or galvannealed layer 1 and the base steel sheet 2. In this way, down to a depth of the sheet that was 100 μm, Vickers hardnesses at the individual points were measured. In FIG. 3, each X shows one of the Vickers hardness measuring points. The interval between any adjacent two of the measuring points, that is, the distance between adjacent two of Xs in FIG. 3 was set to at lowest 15 μm or more. At each of the depths, the Vickers hardness was measured one time (n=1) to examine the hardness distribution in the sheet-thickness-inside direction. Furthermore, a Vickers hardness meter was used to measure the Vickers hardness of a portion of t/4 of the base steel sheet, wherein “t” represents a sheet thickness of the base steel sheet, under a load of 1 kgf (n=1). A region having a Vickers harness of 90% or less of the Vickers hardness of the portion of t/4 of the base steel sheet was defined as a soft layer. The depth thereof was calculated. The same test was made at 10 sites of the same test piece. The average of the resultant values was defined as the average depth D (μm) of the soft layer. The results are shown in Tables 5 to 7 described below. Tables 5 to 7 also show results of the samples that were each obtained by calculating out the value of D/2d on the basis of the average depth d of the internal oxidized layer and that D of the soft layer in each of the samples.

(4) Method for Measuring Phase Fraction of Each of Plated Steel Sheets

The metallic structure of the base steel sheet constituting the plated steel sheet was observed by steps described below. About its low-temperature-transformation produced phase, polygonal ferrite, and retained γ, the respective structure fractions thereof were gained. The low-temperature-transformation produced phase was divided to high-temperature-range produced bainite, or low-temperature-range produced bainite analogs, and the respective area fractions were gained. Specifically, the respective proportions by area of high-temperature-range produced bainite and low-temperature-range produced bainite analogs (i.e., low-temperature-range produced bainite+tempered martensite), and polygonal ferrite, out of the metallic structure, were calculated out on the basis of results obtained through scanning electron microscope (SEM) observation. The proportion by volume of retained γ was measured by a saturation magnetization method.

(4-1) Respective Proportions by Area of High-Temperature-Range Produced Bainite, Low-Temperature-Range Produced Bainite Analogs, and Polygonal Ferrite

The surface of a cross section of the base steel sheet that was parallel to the rolling direction was polished, further electro-polished, and then subjected to nital corrosion. A ¼ site in the sheet thickness direction of the base steel sheet was observed at five visual fields through the SEM at a magnification of 3000. Each of the observed visual fields was rendered an area of about 50 μm×about 50 μm size.

Next, in the observed visual fields, the average interval between adjacent grains of retained γ, observed as white or thinly gray areas, and carbide was measured on the basis of the above-mentioned method. The respective proportions by area of the high-temperature-range produced bainite, and the low-temperature-range produced bainite analogs, which were distinguished by the above-mentioned average intervals, were measured by a point counting method.

The resultant results are shown in Tables 5 to 7 described below under conditions that the proportion by area of the high-temperature-range produced bainite, that of the total of the low-temperature-range produced bainite and the tempered martensite, and that of the polygonal ferrite were represented by “a” (%), “b” (%) and “c” (%), respectively. The total of the proportion “a” by area and proportion “b” by area is the proportion by area of the low-temperature-range produced bainite.

(4-2) Proportion by Volume of Retained γ

The proportion by volume of retained γ, out of metallic structure of the base steel sheet, was measured by the saturation magnetization method. Specifically, measurements were made about the saturation magnetization I of the base steel sheet and the saturation magnetization Is of a standard sample treated thermally at 400° C. for 15 hours. From an equation described below, the proportion Vγr by volume was gained. In the saturation magnetization measurements, a current magnetization B-H property automatic recorder “model BHIS-40” manufactured by Riken Denshi Co., Ltd. was used at room temperature, and a maximum magnetization to be applied was set to 5000 Oe. The results are shown in Tables 5 to 7.

Vγr=(1−l/ls)×100

(4-3) Proportion of the Number of MA Mixed Phase Grains

The surface of a cross section of the base steel sheet that was parallel to the rolling direction was polished, and the surface was observed at five visual fields through an optical microscope at a magnification of 1000. In this way, observed was the equivalent circular diameter of each of MA mixed phase grains in which retained γ and tempered martensite were composite with each other. Calculation was made about the proportion of the number of MA mixed phase grains each having an equivalent circular diameter more than 5 μm to the number of all the MA mixed phase grains in the observed cross section. In any case where no MA mixed phase grains were observed or the proportion thereof by number was less than 15%, the sample of the case was judged as A. In any case where the proportion by number was 15% or more, the sample of the case was judged as B. The evaluated results are shown in Tables 5 to 7. In the present invention, the judgement A is preferred.

(4-4) In some of the base steel sheets, metallic structure such as perlite was recognized, as well as the low-temperature-range produced bainite, the polygonal ferrite and the retained γ.

(5) Evaluation of Mechanical Properties

Mechanical properties of each of the plated steel sheets were evaluated about the tensile strength TS, the elongation EL, the hole expandability λ, and limiting bend radius R.

(5-1) The tensile strength TS and the elongation EL were measured by making a tensile test on the basis of JIS Z2241. A used test piece was a No. 5 test piece prescribed in JIS Z2201, which was cut out from the plated steel sheet to render the longitudinal direction of the piece a direction perpendicular to the rolled direction of the plated steel sheet. Results obtained by measuring the tensile strength TS and the elongation EL are shown in Tables 5 to 7 described below.

(5-2) The hole expandability was evaluated through the hole expanding ratio λ of the plated steel sheet. The hole expanding ratio λ was measured by making a hole expanding test on the basis of Japan Iron and Steel Federation Standards JFS T1001. In detail, the plated steel sheet was punched out to make a hole of 10 mm diameter, and then the circumference of the hole was cramped. In this state, a 60° conical punch was pushed into the hole. When the steel sheet reached a crack generation limit, the diameter of the hole was measured. From an equation described below, the hole expanding ratio λ(%) was gained. In the equation, Df represents the diameter (mm) of the hole at the crack generation limit time, and D0 represents the initial diameter (mm) of the hole. The results are shown in Tables 5 to 7.

Hole expanding ratio λ (%)={(Df−D0)/D0)}×100

(5-3) The bendability was evaluated through the limiting bend radius R of the steel sheet. The limiting bend radius R was measured by making V-bending test on the basis of JIS 72248. A used test piece was a No. 1 test piece prescribed in JIS Z2204, which was cut out from the plated steel sheet to render the longitudinal direction of the test piece a direction perpendicular to the rolled direction of the plated steel sheet, that is, to make the bending ridge consistent with the rolled direction. The sheet thickness of the test piece was 1.4 mm. The V-bending test was made after end surfaces in the longitudinal direction of the test piece were mechanically polished not to crack the test piece.

The V-bending test was made in such a manner that the angle between the die and the punch was set to 90°, and the tip radius of the punch was being changed at intervals of 0.5 mm. The punch tip radius making it possible to bend the test piece without being cracked was gained as the limiting bend radius R. The results are shown in Tables 5 to 7. A loupe was used to observe the test piece, and whether or not the test piece was cracked was judged, using non-generation of any hair crack as a criterion.

The mechanical properties of the plated steel sheet were evaluated in accordance with the metallic structure of the steel sheet, and criteria of the elongation EL corresponding to the tensile strength TS, the hole expanding ratio λ and the limiting bend radius R. Specifically, when the produced amount of high-temperature-range produced bainite, out of the low-temperature-transformation produced phase species, is increased, the elongation out of the mechanical properties is improved. When the produced amount of low-temperature-range produced bainite is increased, the hole expandability out of the mechanical properties is easily improved. Moreover, the mechanical properties of the steel sheet are largely affected by the tensile strength TS of the steel sheet. Accordingly, in accordance with the metallic structure and the tensile strength TS of the steel sheet, required EL, λ and R are varied. Thus, in the present invention, the mechanical properties were evaluated in accordance with criteria shown in Table 8 described below, correspondingly to the metallic structure and the tensile strength TS level of the steel sheet. In Table 8, high-temperature-range produced bainite mainly-made structure denotes the metallic structure described in the case (C6-1), and denotes that the proportion of high-temperature-range produced bainite is more than 50% by area and 95% or less by area of the whole of the metallic structure, the metallic structure may include low-temperature-range produced bainite and tempered martensite, and the proportion of the low-temperature-range produced bainite and the tempered martensite is 0% or more by area and less than 20% by area of the whole of the metallic structure. The composite structure of high-temperature-range produced bainite and low-temperature-range produced bainite analogs denote the metallic structure described in the case (C6-2), and denotes that the proportion of high-temperature-range produced bainite is from 20 to 80% by area of the whole of the metallic structure, and the proportion of low-temperature-range produced bainite and tempered martensite is from 20 to 80% by area of the whole of the metallic structure. Low-temperature-range produced bainite analog mainly-made structure denotes the metallic structure described in the case (C6-3), and denotes that the proportion of low-temperature-range produced bainite is more than 50% by area and 95% or less by area of the whole of the metallic structure, the metallic structure may include high-temperature-range produced bainite, and the proportion of the high-temperature-range produced bainite is 0% or more by area and less than 20% by area of the whole of the metallic structure.

In any case where all properties of EL, λ and R were satisfied on the basis of the above-mentioned evaluation criteria, the case was judged to be acceptable. In any case where any one of the properties was not satisfied, the case was judged to be unacceptable. A premise of the present invention is that TS is 980 MPa or more. Any case where the TS is less than 980 MPa is handled as a case out of the scope of the present invention even when the case has good EL, λ and R.

(6) Delayed Fracture Resistance Test

A portion of W/4 of the plated steel sheet, which was a cross section of the steel sheet that was perpendicular to the sheet-width-W direction of the sheet, was made naked, and therefrom a test piece of 150 mm (W)×30 mm (L) size was cut out. The piece was bent at a minimum bending radius, and then portions of the bent piece were fastened to each other with a bolt. A tensile stress of 1000 MPa was loaded onto an outer surface of the U-bent test piece. In the tensile stress measurement, a strain gauge was fitted to the outside of the U-bent test piece, and the resultant strain was converted to the tensile stress of the test piece. Thereafter, any edge of the U-bent test piece was masked, and hydrogen was electrochemically charged thereinto. The hydrogen charging was performed at room temperature and a constant current of 100 μA/mm² in the state of being immersed into a mixed solution of 0.1-M H₂SO₄ (pH=3) and 0.01-M KSCN. As a result of the hydrogen charging test, in any case where the test piece was not cracked over 24 hours, the case was judged to be acceptable. In other words, the case was judged to be excellent in delayed fracture resistance. The judgment results are shown in Tables 5 to 7.

(7) Galvanizing or Galvannealing External Appearance

The external appearance of the plated steel sheet was visually observed and then the galvanizability thereof was evaluated on the basis of whether or not a bare spot was generated. Whether or not the bare spot was generated is shown in Tables 5 to 7.

From Tables 5 to 7, considerations can be made as follows:

Nos. 1-19, 25-30, 41, and 44-52 were each an example satisfying the requirements of the present invention, and good in all of strength, formabilities [elongations EL, hole expanding ratio λ, and limiting bend radius R], and gave no bare spots. In particular, No. 29, in which the average depth d of the internal oxidized layer and the average depth D of the soft layer satisfied the relationship of D>2d, and the “D/2d” value was more than 1.00 (D/2d=1.20) in Tables 4 and 5, was better in bendability than No. 8, in which the relationship was not satisfied (D/2d=0.81). The same tendency was recognized in No. 30, in which the average depth d of the internal oxidized layer and the average depth D of the soft layer satisfied the relationship of D>2d (D/2d=1.16), and No. 12, in which this relationship was not satisfied (D/2d=0.85).

In contrast, Nos. 20-24, 31-39, 42 and 43 were examples which did not satisfy one or more of the requirements specified in the present invention.

No. 20 was an example small in C amount to be small in produced amount of retained γ, and be short in strength.

No. 21 was an example which was small in Si amount not to produce an internal oxidized layer sufficiently, and had a lowered bendability and delayed fracture resistance.

No. 22 was an example small in Mn amount, and was bad in quenchability to produce polygonal ferrite excessively. Thus, a low-temperature-transformation produced phase was not sufficiently produced. The produced amount of retained γ was also small. Consequently, the TS was lowered.

Nos. 23 and 31 were examples low in coiling temperature in the hot rolling. The average depth of their internal oxidized layer was small after the pickling and the cold rolling. After the galvanizing, the average depth d of the internal oxidized layer and the average depth D of their soft layer were also small. Consequently, the bendability, the delayed fracture resistance, and the galvanizability were lowered.

No. 24 was an example insufficient in temperature keeping temperature in the hot rolling. The average depth d of its internal oxidized layer was small after the pickling and the cold rolling. Thus, after the galvanizing, the average depth d of the internal oxidized layer and the average depth D of its soft layer were also small. Consequently, the bendability, the delayed fracture resistance, and the galvanizability were lowered.

Nos. 32 and 44 were examples long in picking period. Their internal oxidized layer was melted so that a desired average depth d of the internal oxidized layer and a desired average depth D of their soft layer were not obtained. Thus, these layers were shallow. Consequently, the bendability, the delayed fracture resistance, and the galvanizability were lowered.

Nos. 33 and 43 were examples in which the air ratio in the oxidizing furnace was low. Thus, an Fe oxidized film was not sufficiently produced so that the galvanizability was lowered. Moreover, the soft layer was not sufficiently produced so that the bendability and the delayed fracture resistance were also lowered.

No. 34 was an example in which the soaking temperature in the annealing was low so that the steel sheet was annealed in the two phase region. Polygonal ferrite was excessively produced, and a low-temperature-transformation produced phase was not sufficiently produced. Consequently, a desired hard layer was not gained so that the X was lowered.

No. 35 was an example in which the average slow cooling rate was small after the soaking in the annealing. During the cooling, polygonal ferrite was excessively produced so that a low-temperature-transformation produced phase was not sufficiently produced. Retained γ was not sufficiently produced, either. Consequently, the TS was lowered.

No. 36 was an example in which the austempering period was too short. Phases such as lump-form MA mixed phase were excessively produced, and a low-temperature-transformation produced phase was not sufficiently produced. As a result, the λ was low, and the bendability was also lowered.

No. 37 was an example in which the average rapid cooling rate was too low after the soaking. After the austempering, non-transformed portions remained in a large proportion. A low-temperature-transformation produced phase was not sufficiently produced. Consequently, the λ was low, and the bendability was lowered.

No. 38 was an example in which the cooling stopping temperature was too low after the soaking. Retained γ was not sufficiently produced. Consequently, the EL was lowered.

No. 39 was an example in which the average rapid cooling rate was too high after the soaking. Polygonal ferrite was excessively produced so that a low-temperature-transformation produced phase was not sufficiently produced. Consequently, the λ was low, and the bendability was also lowered.

TABLE 1

| Steel | Component composition (% by mass) | | | | | | | | | | | | | | | | | | |
|---|---|---|---|---|---|---|---|---|---|---|---|---|---|---|---|---|---|---|---|
| species | C | Si | Mn | P | S | Al | Cr | Mo | Ti | Nb | V | Cu | Ni | B | Ca | Mg | REM | N | O |
| 1 | 0.18 | 1.26 | 2.19 | 0.03 | 0.001 | 0.04 | — | — | — | — | — | — | — | — | — | — | — | 0.002 | 0.001 |
| 2 | 0.23 | 1.36 | 2.28 | 0.02 | 0.001 | 0.03 | — | — | — | — | — | — | — | — | — | — | — | 0.003 | 0.001 |
| 3 | 0.19 | 1.88 | 1.95 | 0.02 | 0.001 | 0.06 | — | — | — | — | — | — | — | — | — | — | — | 0.004 | 0.002 |
| 4 | 0.15 | 1.31 | 2.13 | 0.01 | 0.001 | 0.06 | — | — | — | — | — | — | — | — | — | — | — | 0.004 | 0.001 |
| 5 | 0.35 | 1.03 | 1.81 | 0.02 | 0.001 | 0.05 | — | — | — | — | — | — | — | — | — | — | — | 0.003 | 0.002 |
| 6 | 0.16 | 2.29 | 2.41 | 0.02 | 0.001 | 0.02 | — | — | — | — | — | — | — | — | — | — | — | 0.004 | 0.001 |
| 7 | 0.14 | 1.07 | 5.13 | 0.03 | 0.002 | 0.02 | — | — | — | — | — | — | — | — | — | — | — | 0.006 | 0.002 |
| 8 | 0.19 | 1.93 | 2.60 | 0.02 | 0.002 | 0.03 | — | — | — | — | — | — | — | — | — | — | — | 0.006 | 0.001 |
| 9 | 0.17 | 1.32 | 1.85 | 0.03 | 0.002 | 0.04 | 0.3 | — | — | — | — | — | — | — | — | — | — | 0.005 | 0.001 |
| 10 | 0.16 | 1.31 | 1.76 | 0.02 | 0.002 | 0.03 | — | 0.4 | — | — | — | — | — | — | — | — | — | 0.004 | 0.001 |
| 11 | 0.20 | 1.82 | 2.03 | 0.02 | 0.001 | 0.05 | — | — | 0.09 | — | — | — | — | — | — | — | — | 0.004 | 0.001 |
| 12 | 0.17 | 1.36 | 2.38 | 0.01 | 0.002 | 0.05 | — | — | — | 0.13 | — | — | — | — | — | — | — | 0.004 | 0.002 |
| 13 | 0.23 | 1.53 | 2.23 | 0.02 | 0.001 | 0.05 | — | — | — | — | 0.15 | — | — | — | — | — | — | 0.003 | 0.001 |
| 14 | 0.32 | 1.82 | 2.30 | 0.01 | 0.001 | 0.04 | — | — | — | — | — | 0.23 | 0.20 | — | — | — | — | 0.006 | 0.001 |
| 15 | 0.21 | 1.85 | 2.38 | 0.02 | 0.001 | 0.06 | — | — | — | — | — | — | — | 0.0035 | — | — | — | 0.004 | 0.002 |
| 16 | 0.22 | 1.84 | 2.44 | 0.02 | 0.001 | 0.04 | — | — | 0.02 | — | — | — | — | 0.0022 | — | — | — | 0.003 | 0.001 |
| 17 | 0.17 | 1.31 | 2.17 | 0.03 | 0.001 | 0.04 | — | — | — | — | — | — | — | — | 0.0021 | — | — | 0.005 | 0.002 |
| 18 | 0.22 | 1.11 | 2.54 | 0.03 | 0.001 | 0.41 | — | — | — | — | — | — | — | — | — | 0.0023 | — | 0.006 | 0.001 |
| 19 | 0.23 | 1.78 | 2.34 | 0.03 | 0.001 | 0.06 | — | — | — | — | — | — | — | — | — | — | 0.0018 | 0.006 | 0.001 |
| 20 | 0.08 | 2.08 | 2.26 | 0.02 | 0.002 | 0.02 | — | — | — | — | — | — | — | — | — | — | — | 0.004 | 0.001 |
| 21 | 0.19 | 0.43 | 2.28 | 0.03 | 0.001 | 0.04 | — | — | — | — | — | — | — | — | — | — | — | 0.006 | 0.002 |
| 22 | 0.21 | 1.57 | 1.25 | 0.03 | 0.002 | 0.06 | — | — | — | — | — | — | — | — | — | — | — | 0.004 | 0.001 |
| 23 | 0.21 | 1.87 | 1.95 | 0.01 | 0.002 | 0.03 | 0.1 | — | — | — | — | — | — | — | — | — | — | 0.003 | 0.002 |
| 24 | 0.21 | 1.83 | 2.10 | 0.01 | 0.002 | 0.03 | 0.2 | — | 0.02 | — | — | — | — | — | — | — | — | 0.004 | 0.002 |
| 25 | 0.21 | 1.45 | 2.19 | 0.01 | 0.002 | 0.06 | — | — | 0.07 | — | — | — | — | — | — | — | — | 0.005 | 0.002 |

TABLE 2

| | | Hot rolling | | | Pickling | | Annealing | | |
|---|---|---|---|---|---|---|---|---|---|
| | | | | Temperature | | Internal | Oxidizing | Highest | |
| | | Coiling | | keeping | Pickling | oxidized layer | furnace | arrival | |
| | Steel | temperature | Temperature | period | period | average depth | air | temperature | Ac₃ |
| No. | species | (° C.) | keeping | (minutes) | (seconds) | (μm) | ratio | (° C.) | (° C.) |
| 1 | 1 | 650 | Not done | — | 40 | 12 | 1.1 | 880 | 849 |
| 2 | 2 | 650 | Not done | — | 40 | 12 | 1.1 | 880 | 831 |
| 3 | 3 | 650 | Not done | — | 40 | 12 | 1.1 | 910 | 884 |
| 4 | 4 | 650 | Not done | — | 40 | 13 | 1.1 | 910 | 860 |
| 5 | 5 | 630 | Not done | — | 40 | 12 | 1.1 | 850 | 818 |
| 6 | 6 | 660 | Not done | — | 40 | 13 | 1.1 | 910 | 882 |
| 7 | 7 | 680 | Not done | — | 40 | 14 | 1.1 | 820 | 757 |
| 8 | 8 | 660 | Not done | — | 40 | 15 | 0.9 | 880 | 855 |
| 9 | 9 | 650 | Not done | — | 40 | 12 | 1.1 | 880 | 860 |
| 10 | 10 | 650 | Not done | — | 40 | 13 | 1.1 | 880 | 871 |
| 11 | 11 | 620 | Not done | — | 40 | 12 | 1.1 | 930 | 908 |
| 12 | 12 | 650 | Not done | — | 40 | 15 | 1.0 | 880 | 844 |
| 13 | 13 | 650 | Not done | — | 40 | 11 | 1.1 | 880 | 863 |
| 14 | 14 | 650 | Not done | — | 40 | 14 | 1.1 | 850 | 827 |
| 15 | 15 | 660 | Not done | — | 40 | 14 | 1.1 | 880 | 864 |
| 16 | 16 | 660 | Not done | — | 40 | 15 | 1.1 | 880 | 862 |
| 17 | 17 | 650 | Not done | — | 40 | 12 | 1.1 | 880 | 854 |
| 18 | 18 | 660 | Not done | — | 40 | 12 | 1.1 | 980 | 971 |
| 19 | 19 | 650 | Not done | — | 40 | 13 | 1.1 | 910 | 865 |
| 20 | 20 | 650 | Not done | — | 40 | 11 | 1.1 | 910 | 897 |

| | Annealing | | | | | | | |
|---|---|---|---|---|---|---|---|---|
| | Average | Cooling | | After cooling | | | | |
| | cooling | stopping | | stop, retention | Austempering | | | |
| | rate | temperature | Ms | period | Temperature | Period | Heat | |
| No. | (° C./second) | (° C.) | (° C.) | (seconds) | (° C.) | (seconds) | pattern | Kind |
| 1 | 60 | 400 | — | — | 400 | 100 | a2 | GI |
| 2 | 60 | 380 | — | — | 380 | 60 | a2 | GA |
| 3 | 60 | 300 | 405 | 20 | 460 | 600 | c1 | GI |
| 4 | 60 | 380 | 421 | 20 | 430 | 300 | c1 | GA |
| 5 | 60 | 250 | 334 | 20 | 450 | 300 | c1 | GA |
| 6 | 30 | 480 | — | 15 | 350 | 600 | b | GA |
| 7 | 15 | 150 | 327 | 30 | 420 | 1200 | c1 | GA |
| 8 | 30 | 250 | 383 | 20 | 450 | 60 | c1 | GA |
| 9 | 60 | 480 | — | 20 | 380 | 60 | b | GI |
| 10 | 60 | 400 | — | — | 400 | 600 | a2 | GI |
| 11 | 60 | 250 | 400 | 20 | 440 | 60 | c1 | GI |
| 12 | 30 | 450 | — | 20 | 300 | 300 | b | GA |
| 13 | 60 | 300 | — | — | 300 | 300 | a3 | GA |
| 14 | 30 | 150 | — | 20 | 350 | 300 | a3 | GI |
| 15 | 30 | 250 | — | — | 250 | 600 | a3 | GA |
| 16 | 30 | 300 | 377 | 10 | 450 | 40 | c1 | GA |
| 17 | 60 | 450 | — | 10 | 380 | 60 | b | GA |
| 18 | 30 | 300 | — | — | 300 | 600 | a3 | GA |
| 19 | 30 | 200 | 376 | 10 | 420 | 300 | c2 | GI |
| 20 | 60 | 420 | — | — | 420 | 100 | a1 | GA |

TABLE 3

| | | Hot rolling | | | Pickling | | Annealing | | |
|---|---|---|---|---|---|---|---|---|---|
| | | | | Temperature | | Internal | Oxidizing | Highest | |
| | | Coiling | | keeping | Pickling | oxidized layer | furnace | arrival | |
| | Steel | temperature | Temperature | period | period | average depth | air | temperature | Ac₃ |
| No. | species | (° C.) | keeping | (minutes) | (seconds) | (μm) | ratio | (° C.) | (° C.) |
| 21 | 21 | 650 | Not done | — | 40 | 2 | 1.1 | 850 | 807 |
| 22 | 22 | 650 | Not done | — | 40 | 14 | 1.1 | 910 | 891 |
| 23 | 1 | 520 | Not done | — | 40 | 1 | 1.1 | 880 | 849 |
| 24 | 1 | 580 | Done | 40 | 40 | 3 | 1.1 | 880 | 849 |
| 25 | 2 | 580 | Done | 180 | 40 | 13 | 1.1 | 880 | 831 |
| 26 | 4 | 580 | Done | 120 | 40 | 12 | 1.1 | 910 | 860 |
| 27 | 5 | 580 | Done | 600 | 40 | 13 | 1.1 | 850 | 818 |
| 28 | 7 | 580 | Done | 180 | 40 | 13 | 1.1 | 820 | 757 |
| 29 | 8 | 580 | Done | 120 | 40 | 14 | 1.1 | 880 | 855 |
| 30 | 12 | 580 | Done | 120 | 40 | 15 | 1.1 | 880 | 844 |
| 31 | 1 | 450 | Done | 180 | 40 | 1 | 1.1 | 880 | 849 |
| 32 | 1 | 650 | Done | 180 | 250 | 0 | 1.1 | 880 | 849 |
| 33 | 2 | 650 | Not done | — | 40 | 12 | 0.8 | 880 | 831 |
| 34 | 4 | 650 | Not done | — | 40 | 10 | 1.1 | 820 | 860 |
| 35 | 4 | 580 | Done | 120 | 40 | 12 | 1.1 | 910 | 860 |
| 36 | 4 | 650 | Not done | — | 40 | 11 | 1.1 | 910 | 860 |
| 37 | 8 | 580 | Done | 300 | 40 | 11 | 1.1 | 880 | 855 |
| 38 | 8 | 660 | Not done | — | 40 | 12 | 1.1 | 880 | 855 |
| 39 | 8 | 580 | Done | 180 | 40 | 12 | 1.1 | 880 | 855 |

| | Annealing | | | | | | | |
|---|---|---|---|---|---|---|---|---|
| | Average | Cooling | | After cooling | | | | |
| | cooling | stopping | | stop, retention | Austempering | | | |
| | rate | temperature | Ms | period | Temperature | Period | Heat | |
| No. | (° C./second) | (° C.) | (° C.) | (seconds) | (° C.) | (seconds) | pattern | Kind |
| 21 | 60 | 400 | — | — | 400 | 100 | a2 | GA |
| 22 | 60 | 400 | — | — | 400 | 100 | a2 | GA |
| 23 | 60 | 400 | — | — | 400 | 100 | a2 | GA |
| 24 | 60 | 250 | — | — | 250 | 300 | a3 | GI |
| 25 | 60 | 440 | — | — | 440 | 300 | a1 | GI |
| 26 | 60 | 350 | 421 | 20 | 450 | 60 | c1 | GI |
| 27 | 60 | 200 | — | 20 | 350 | 300 | a3 | GI |
| 28 | 15 | 120 | 327 | 20 | 450 | 1200 | c1 | GA |
| 29 | 30 | 250 | 383 | 20 | 450 | 60 | c1 | GI |
| 30 | 30 | 450 | — | 20 | 300 | 300 | b | GI |
| 31 | 60 | 380 | — | — | 380 | 600 | a2 | GA |
| 32 | 60 | 300 | — | — | 300 | 300 | a3 | GI |
| 33 | 60 | 400 | — | — | 400 | 300 | a2 | GI |
| 34 | 60 | 440 | — | — | 440 | 600 | a1 | GI |
| 35 | 5 | 380 | — | — | 380 | 300 | a2 | GA |
| 36 | 60 | 380 | — | — | 380 | 20 | a2 | GA |
| 37 | 60 | 150 | — | — | 80 | 600 | a3 | GI |
| 38 | 60 | 50 | — | 20 | 420 | 600 | — | GA |
| 39 | 60 | 600 | — | 40 | 380 | 600 | — | GI |

TABLE 4

| | | Hot rolling | | | Pickling | | Annealing | | |
|---|---|---|---|---|---|---|---|---|---|
| | | | | Temperature | | Internal | Oxidizing | Highest | |
| | | Coiling | | keeping | Pickling | oxidized layer | furnace | arrival | |
| | Steel | temperature | Temperature | period | period | average depth | air | temperature | Ac₃ |
| No. | species | (° C.) | keeping | (minutes) | (seconds) | (μm) | ratio | (° C.) | (° C.) |
| 41 | 1 | 550 | Done | 180 | 60 | 11 | 1.1 | 880 | 849 |
| 42 | 1 | 650 | Not done | — | 210 | 2 | 1.1 | 880 | 849 |
| 43 | 2 | 650 | Done | 120 | 60 | 13 | 0.8 | 880 | 831 |
| 44 | 2 | 650 | Not done | — | 80 | 11 | 1.1 | 880 | 831 |
| 45 | 2 | 650 | Not done | — | 80 | 10 | 1.2 | 880 | 831 |
| 46 | 4 | 650 | Not done | — | 80 | 11 | 1.2 | 910 | 860 |
| 47 | 4 | 580 | Done | 180 | 60 | 14 | 1.0 | 910 | 860 |
| 48 | 7 | 650 | Not done | — | 60 | 10 | 1.1 | 880 | 757 |
| 49 | 7 | 550 | Done | 120 | 40 | 13 | 1.0 | 880 | 757 |
| 50 | 23 | 550 | Done | 180 | 40 | 13 | 1.1 | 880 | 862 |
| 51 | 24 | 550 | Done | 120 | 40 | 14 | 1.2 | 880 | 862 |
| 52 | 25 | 650 | Not done | — | 60 | 12 | 1.0 | 880 | 876 |

| | Annealing | | | | | | | |
|---|---|---|---|---|---|---|---|---|
| | Average | Cooling | | After cooling | | | | |
| | cooling | stopping | | stop, retention | Austempering | | | |
| | rate | temperature | Ms | period | Temperature | Period | Heat | |
| No. | (° C./second) | (° C.) | (° C.) | (seconds) | (° C.) | (seconds) | pattern | Kind |
| 41 | 45 | 350 | 405 | 20 | 420 | 300 | c1 | GI |
| 42 | 60 | 380 | — | — | 380 | 1200 | a2 | GA |
| 43 | 45 | 420 | — | — | 380 | 600 | b | GI |
| 44 | 60 | 450 | — | 20 | 450 | 600 | a1 | GA |
| 45 | 60 | 200 | — | — | 200 | 600 | a3 | GI |
| 46 | 60 | 450 | — | — | 450 | 600 | a1 | GA |
| 47 | 60 | 350 | 421 | 40 | 420 | 300 | c1 | GA |
| 48 | 15 | 200 | 327 | 20 | 450 | 60 | c1 | GA |
| 49 | 15 | 150 | — | — | 150 | 100 | a3 | GI |
| 50 | 45 | 420 | — | — | 420 | 60 | a1 | GA |
| 51 | 60 | 250 | 390 | 20 | 420 | 60 | c1 | GA |
| 52 | 45 | 300 | — | — | 300 | 100 | a3 | GA |

TABLE 5

| | | Surface layer structure after galvanizing | | | Structure Fractions | | |
|---|---|---|---|---|---|---|---|
| | | Internal oxidized | Soft layer | | High | Low | a + b |
| | Steel | layer average | average | | temperature a | temperature b | (% by |
| No. | species | depth D (μm) | depth D (μm) | D/2d | (% by area) | (% by area) | area) |
| 1 | 1 | 12 | 26 | 1.08 | 47 | 38 | 85 |
| 2 | 2 | 13 | 32 | 1.23 | 33 | 52 | 85 |
| 3 | 3 | 13 | 33 | 1.27 | 38 | 45 | 83 |
| 4 | 4 | 14 | 28 | 1.00 | 52 | 35 | 87 |
| 5 | 5 | 13 | 31 | 1.19 | 51 | 33 | 84 |
| 6 | 6 | 14 | 28 | 1.00 | 46 | 44 | 90 |
| 7 | 7 | 15 | 31 | 1.03 | 22 | 61 | 83 |
| 8 | 8 | 16 | 26 | 0.81 | 34 | 57 | 91 |
| 9 | 9 | 12 | 34 | 1.42 | 46 | 41 | 87 |
| 10 | 10 | 14 | 33 | 1.18 | 48 | 40 | 88 |
| 11 | 11 | 13 | 29 | 1.12 | 35 | 48 | 83 |
| 12 | 12 | 17 | 29 | 0.85 | 49 | 37 | 86 |
| 13 | 13 | 12 | 33 | 1.38 | 5 | 85 | 90 |
| 14 | 14 | 15 | 32 | 1.07 | 3 | 89 | 92 |
| 15 | 15 | 14 | 31 | 1.11 | 0 | 91 | 91 |
| 16 | 16 | 15 | 33 | 1.10 | 26 | 64 | 90 |
| 17 | 17 | 13 | 32 | 1.23 | 44 | 41 | 85 |
| 18 | 18 | 13 | 35 | 1.35 | 0 | 90 | 90 |
| 19 | 19 | 14 | 33 | 1.18 | 12 | 78 | 90 |
| 20 | 20 | 12 | 27 | 1.13 | 53 | 41 | 94 |

| | Structure Fractions | | | | | | | | |
|---|---|---|---|---|---|---|---|---|---|
| | Ferrite c | Retained γ | MA | Mechanical properties | | | | Delayed | |
| | (% by | (% by | mixed | TS | EL | λ | R | fracture | Bare |
| No. | area) | volume) | phase | (MPa) | (%) | (%) | (mm) | resistance | spots |
| 1 | 0 | 13 | A | 1025 | 15 | 47 | 1.0 | Acceptable | Not found |
| 2 | 0 | 13 | A | 1087 | 14 | 53 | 0.5 | Acceptable | Not found |
| 3 | 5 | 12 | A | 1226 | 16 | 51 | 1.0 | Acceptable | Not found |
| 4 | 0 | 12 | A | 1017 | 15 | 59 | 0.0 | Acceptable | Not found |
| 5 | 0 | 17 | A | 1264 | 20 | 43 | 1.5 | Acceptable | Not found |
| 6 | 0 | 13 | A | 1034 | 18 | 55 | 0.5 | Acceptable | Not found |
| 7 | 0 | 18 | A | 1239 | 20 | 36 | 2.0 | Acceptable | Not found |
| 8 | 0 | 11 | A | 1212 | 15 | 36 | 2.0 | Acceptable | Not found |
| 9 | 0 | 14 | A | 1082 | 14 | 48 | 1.0 | Acceptable | Not found |
| 10 | 0 | 14 | A | 1035 | 15 | 47 | 0.5 | Acceptable | Not found |
| 11 | 4 | 15 | A | 1188 | 15 | 46 | 1.0 | Acceptable | Not found |
| 12 | 0 | 13 | A | 1052 | 19 | 41 | 1.0 | Acceptable | Not found |
| 13 | 0 | 12 | A | 1232 | 14 | 44 | 1.5 | Acceptable | Not found |
| 14 | 0 | 10 | A | 1386 | 17 | 46 | 2.0 | Acceptable | Not found |
| 15 | 0 | 9 | A | 1293 | 12 | 37 | 2.5 | Acceptable | Not found |
| 16 | 0 | 11 | A | 1238 | 15 | 34 | 1.5 | Acceptable | Not found |
| 17 | 3 | 13 | A | 1040 | 15 | 56 | 0.0 | Acceptable | Not found |
| 18 | 0 | 11 | A | 1230 | 12 | 43 | 1.5 | Acceptable | Not found |
| 19 | 0 | 12 | A | 1192 | 12 | 55 | 2.0 | Acceptable | Not found |
| 20 | 3 | 4 | A | 911 | 17 | 43 | 0.0 | Acceptable | Not found |

TABLE 6

| | | Surface layer structure after galvanizing | | | Structure Fractions | | |
|---|---|---|---|---|---|---|---|
| | | Internal oxidized | Soft layer | | High | Low | a + b |
| | Steel | layer average | average | | temperature a | temperature b | (% by |
| No. | species | depth D (μm) | depth D (μm) | D/2d | (% by area) | (% by area) | area) |
| 21 | 21 | 3 | 20 | 3.33 | 49 | 44 | 93 |
| 22 | 22 | 16 | 36 | 1.13 | 4 | 8 | 12 |
| 23 | 1 | 2 | 17 | 4.25 | 48 | 39 | 87 |
| 24 | 1 | 3 | 16 | 2.67 | 0 | 89 | 89 |
| 25 | 2 | 14 | 29 | 1.04 | 79 | 3 | 82 |
| 26 | 4 | 12 | 29 | 1.21 | 38 | 51 | 89 |
| 27 | 5 | 14 | 32 | 1.14 | 12 | 74 | 86 |
| 28 | 7 | 15 | 38 | 1.27 | 23 | 64 | 87 |
| 29 | 8 | 15 | 36 | 1.20 | 31 | 58 | 89 |
| 30 | 12 | 16 | 37 | 1.16 | 45 | 41 | 86 |
| 31 | 1 | 2 | 18 | 4.50 | 17 | 73 | 90 |
| 32 | 1 | 2 | 15 | 3.75 | 5 | 87 | 92 |
| 33 | 2 | 14 | 18 | 0.64 | 67 | 23 | 90 |
| 34 | 4 | 12 | 30 | 1.25 | 35 | 7 | 42 |
| 35 | 4 | 13 | 30 | 1.15 | 4 | 8 | 12 |
| 36 | 4 | 12 | 33 | 1.38 | 43 | 3 | 46 |
| 37 | 8 | 12 | 32 | 1.33 | 0 | 64 | 64 |
| 38 | 8 | 13 | 29 | 1.12 | 0 | 91 | 91 |
| 39 | 8 | 12 | 29 | 1.21 | 11 | 33 | 44 |

| | Structure Fractions | | | | | | | | |
|---|---|---|---|---|---|---|---|---|---|
| | Ferrite c | Retained γ | MA | Mechanical properties | | | | Delayed | |
| | (% by | (% by | mixed | TS | EL | λ | R | fracture | Bare |
| No. | area) | volume) | phase | (MPa) | (%) | (%) | (mm) | resistance | spots |
| 21 | 0 | 8 | A | 1023 | 13 | 53 | 3.5 | Unacceptable | Not found |
| 22 | 61 | 3 | A | 933 | 15 | 37 | 0.5 | Acceptable | Not found |
| 23 | 0 | 14 | A | 1032 | 18 | 57 | 3.0 | Unacceptable | Found |
| 24 | 0 | 11 | A | 1192 | 11 | 55 | 3.5 | Unacceptable | Found |
| 25 | 0 | 15 | B | 1054 | 17 | 23 | 0.0 | Acceptable | Not found |
| 26 | 0 | 13 | A | 1034 | 14 | 74 | 0.0 | Acceptable | Not found |
| 27 | 0 | 15 | A | 1280 | 20 | 44 | 2.0 | Acceptable | Not found |
| 28 | 0 | 17 | A | 1328 | 17 | 26 | 3.0 | Acceptable | Not found |
| 29 | 0 | 12 | A | 1222 | 15 | 45 | 1.0 | Acceptable | Not found |
| 30 | 0 | 14 | A | 1061 | 19 | 41 | 0.5 | Acceptable | Not found |
| 31 | 0 | 11 | A | 1075 | 15 | 45 | 3.5 | Unacceptable | Found |
| 32 | 0 | 11 | A | 1093 | 14 | 48 | 3.0 | Unacceptable | Found |
| 33 | 0 | 14 | A | 1083 | 15 | 43 | 3.5 | Unacceptable | Found |
| 34 | 44 | 15 | B | 1027 | 23 | 17 | 1.5 | Acceptable | Not found |
| 35 | 55 | 2 | A | 867 | 15 | 45 | 2.0 | Acceptable | Not found |
| 36 | 0 | 12 | B | 1362 | 14 | 15 | 4.5 | Acceptable | Not found |
| 37 | 0 | 11 | B | 1326 | 13 | 18 | 4.5 | Acceptable | Not found |
| 38 | 0 | 4 | A | 1387 | 7 | 47 | 3.0 | Acceptable | Not found |
| 39 | 45 | 13 | B | 1188 | 16 | 18 | 3.5 | Acceptable | Not found |

TABLE 7

| | | Surface layer structure after galvanizing | | | Structure Fractions | | |
|---|---|---|---|---|---|---|---|
| | | Internal oxidized | Soft layer | | High | Low | a + b |
| | Steel | layer average | average | | temperature a | temperature b | (% by |
| No. | species | depth D (μm) | depth D (μm) | D/2d | (% by area) | (% by area) | area) |
| 41 | 1 | 13 | 31 | 1.19 | 47 | 39 | 86 |
| 42 | 1 | 3 | 14 | 2.33 | 20 | 69 | 89 |
| 43 | 2 | 14 | 16 | 0.57 | 45 | 42 | 87 |
| 44 | 2 | 13 | 33 | 1.27 | 75 | 11 | 86 |
| 45 | 2 | 12 | 34 | 1.42 | 5 | 88 | 93 |
| 46 | 4 | 12 | 32 | 1.33 | 89 | 3 | 92 |
| 47 | 4 | 16 | 37 | 1.16 | 39 | 47 | 86 |
| 48 | 7 | 11 | 31 | 1.41 | 31 | 62 | 93 |
| 49 | 7 | 15 | 37 | 1.23 | 5 | 83 | 88 |
| 50 | 23 | 14 | 34 | 1.21 | 82 | 7 | 89 |
| 51 | 24 | 16 | 38 | 1.19 | 37 | 55 | 92 |
| 52 | 25 | 14 | 35 | 1.25 | 9 | 83 | 92 |

| | Structure Fractions | | | | | | | | |
|---|---|---|---|---|---|---|---|---|---|
| | Ferrite c | Retained γ | MA | Mechanical properties | | | | Delayed | |
| | (% by | (% by | mixed | TS | EL | λ | R | fracture | Bare |
| No. | area) | volume) | phase | (MPa) | (%) | (%) | (mm) | resistance | spots |
| 41 | 0 | 13 | A | 1056 | 16 | 56 | 0.0 | Acceptable | Not found |
| 42 | 0 | 12 | A | 1074 | 14 | 52 | 3.0 | Unacceptable | Found |
| 43 | 0 | 15 | A | 1056 | 20 | 41 | 3.5 | Unacceptable | Found |
| 44 | 0 | 14 | B | 1032 | 23 | 26 | 0.5 | Acceptable | Not found |
| 45 | 0 | 7 | A | 1418 | 11 | 44 | 2.0 | Acceptable | Not found |
| 46 | 0 | 14 | B | 1003 | 21 | 23 | 1.0 | Acceptable | Not found |
| 47 | 0 | 12 | A | 1025 | 14 | 62 | 0.0 | Acceptable | Not found |
| 48 | 0 | 13 | A | 1517 | 11 | 47 | 2.5 | Acceptable | Not found |
| 49 | 0 | 12 | A | 1533 | 11 | 56 | 2.0 | Acceptable | Not found |
| 50 | 0 | 15 | B | 1043 | 22 | 25 | 0.5 | Acceptable | Not found |
| 51 | 0 | 10 | A | 1228 | 16 | 43 | 1.0 | Acceptable | Not found |
| 52 | 0 | 12 | A | 1194 | 17 | 45 | 1.0 | Acceptable | Not found |

TABLE 8

| Metallic structure | Section | TS | EL | λ | R |
|---|---|---|---|---|---|
| High-temperature-range | Class 980 | 980 MPa or more less than 1180 MPa | 14.0% or more | 20% or more | 2.0 mm or less |
| produced bainite | Class 1180 | 1180 MPa or more, and less than 1270 MPa | 13.0% or more | 20% or more | 3.5 mm or less |
| mainly-made structure | Class 1270 | 1270 MPa or more, and less than 1370 MPa | 11.0% or more | 20% or more | 4.0 mm or less |
| | Over class 1270 | 1370 MPa or more | 9.0% or more | 15% or more | 5.0 mm or less |
| Composite structure of | Class 980 | 980 MPa or more, and less than 1180 MPa | 14.0% or more | 40% or more | 1.0 mm or less |
| high-temperature-range | Class 1180 | 1180 MPa or more, and less than 1270 MPa | 13.0% or more | 30% or more | 2.5 mm or less |
| produced bainite | Class 1270 | 1270 MPa or more, and less than 1370 MPa | 11.0% or more | 25% or more | 3.0 mm or less |
| low-temperature-range | Over class 1270 | 1370 MPa or more | 9.0% or more | 20% or more | 4.0 mm or less |
| produced bainite analog | | | | | |
| Low-temperature-range | Class 980 | 980 MPa or more less than 1180 MPa | 11.0% or more | 40% or more | 1.0 mm or less |
| produced bainite analog | Class 1180 | 1180 MPa or more, and less than 1270 MPa | 10.0% or more | 30% or more | 2.5 mm or less |
| mainly-made structure | Class 1270 | 1270 MPa or more, and less than 1370 MPa | 8.0% or more | 25% or more | 3.0 mm or less |
| | Over Class 1270 | 1370 MPa or more | 7.0% or more | 20% or more | 4.0 mm or less |

### REFERENCE SIGNS

1 galvanized layer or galvannealed layer
2 base steel sheet
3 internal oxidized layer
4 soft layer
5 hard layer

1: A high-strength plated steel sheet having a hot-dip galvanized layer or a hot-dip galvannealed layer on a surface of a base steel sheet, the base steel sheet comprising, in % by mass:
C: 0.10 to 0.5%,
Si: 1 to 3%,
Mn: 1.5 to 8%,
Al: 0.005 to 3%,
P: more than 0% to 0.1% or less,
S: more than 0% to 0.05% or less, and
N: more than 0% to 0.01% or less,
wherein:
the plated steel sheet sequentially comprises, from an interface between the base steel sheet and the galvanized layer or galvannealed layer toward the base steel sheet;
an internal oxidized layer comprising at least one an oxide selected from the group consisting of Si and Mn,
a soft layer comprising the internal oxidized layer, and having a Vickers hardness of 90% or less of a Vickers hardness of a portion of t/4 of the base steel sheet where “t” is a sheet thickness of the base steel sheet, and
a hard layer comprising a structure having metallic structure which comprises, when the metallic structure is observed through a scanning electron microscope, a low-temperature-transformation produced phase in a proportion of 70% or more by area of the whole of the metallic structure, and polygonal ferrite in a proportion of 0 to 10% by area of the whole of the metallic structure;
the metallic structure comprises retained austenite in a proportion of 5% or more by volume of the whole of the metallic structure when the metallic structure is measured by a saturation magnetization method; and
the high-strength plated steel sheet satisfies:
the average depth D of the soft layer being 20 μm or more,
the average depth d of the internal oxidized layer being 4 μm or more and less than D, and
a tensile strength is 980 MPa or more.

2: The high-strength plated steel sheet according to claim 1, wherein the average depth d of the internal oxidized layer and the average depth D of the soft layer satisfy the relationship: D>2d.

3: The high-strength plated steel sheet according to claim 1, wherein:
the low-temperature-transformation produced phase comprises a high-temperature-range produced bainite in which the average interval between adjacent grains of the retained austenite, between adjacent grains of any carbide or between adjacent grains of the retained austenite and the carbide is 1 μm or more;
the proportion of the high-temperature-range produced bainite is more than 50% by area and 95% or less by area of the whole of the metallic structure;
the low-temperature-transformation produced phase may comprise low-temperature-range produced bainite in which the average interval between adjacent grains of the retained austenite, between adjacent grains of any carbide or between adjacent grains of the retained austenite and the carbide is less than 1 μm, and may comprise tempered martensite; and
the proportion of the total of the low-temperature-range produced bainite and the tempered martensite is 0% or more by area and less than 20% by area of the whole of the metallic structure.

4: The high-strength plated steel sheet according to claim 1, wherein:
the low-temperature-transformation produced phase comprises:
a high-temperature-range produced bainite in which the average interval between adjacent grains of the retained austenite, between adjacent grains of any carbide or between adjacent grains of the retained austenite and the carbide is 1 μm or more,
a low-temperature-range produced bainite in which the average interval between adjacent grains of the retained austenite, between adjacent grains of any carbide or between adjacent grains of the retained austenite and the carbide is less than 1 μm, and
a tempered martensite;
the proportion of the high-temperature-range produced bainite is from 20 to 80% by area of the whole of the metallic structure; and
the proportion of the total of the low-temperature-range produced bainite and the tempered martensite is from 20 to 80% by area of the whole of the metallic structure.

5: The high-strength plated steel sheet according to claim 1, wherein:
the low-temperature-transformation produced phase comprises a low-temperature-range produced bainite in which the average interval between adjacent grains of the retained austenite, between adjacent grains of any carbide or between adjacent grains of the retained austenite and the carbide is less than 1 μm, and a tempered martensite;
the proportion of the total of the low-temperature-range produced bainite and the tempered martensite is more than 50% by area and 95% or less by area of the whole of the metallic structure;
the low-temperature-transformation produced phase may comprise high-temperature-range produced bainite in which the average interval between adjacent grains of the retained austenite, between adjacent grains of any carbide or between adjacent grains of the retained austenite and the carbide is 1 μm or more; and
the proportion of the high-temperature-range produced bainite is 0% or more by area and less than 20% by area of the whole of the metallic structure.

6: The high-strength plated steel sheet according to claim 1, wherein the base steel sheet further comprises, in % by mass, at least one of the following (a) to (d):
(a) one or more selected from the group consisting of Cr: more than 0% to 1% or less, Mo: more than 0% to 1% or less, and B: more than 0% to 0.01% or less:
(b) one or more selected from the group consisting of Ti: more than 0% to 0.2% or less, Nb: more than 0% to 0.2% or less, and V: more than 0% to 0.2% or less;
(c) one or more selected from the group consisting of Cu: more than 0% to 1% or less, and Ni: more than 0% to 1% or less; and
(d) one or more selected from the group consisting of Ca: more than 0%, to 0.01% or less, Mg: more than 0% to 0.01% or less, and any rare earth element: more than 0% to 0.01% or less.

7: A method for producing the high-strength plated steel sheet according to claim 1, the method comprising, in order:
a hot-rolling step of coiling a steel sheet having the steel components of said base steel sheet at a temperature of 600° C. or higher;
a step of pickling and cold-rolling the steel sheet such that there remain the internal oxidized layer with an average depth d of 4 μm or more;
a step of oxidizing the steel sheet at an air ratio of 0.9 to 1.4 in an oxidizing zone;
a step of soaking the steel sheet in a temperature range not lower than the A_{c3} point in a reducing zone; and
a step of cooling, after the soaking, the steel sheet to any stopping temperature Z satisfying a temperature from 100 to 540° C., and cooling the steel sheet, in a temperature range from 750° C. to a higher temperature of the stopping temperature Z or 500° C., at an average cooling rate of 10° C./second or more, and retaining the steel sheet in said temperature range of 100 to 540° C. for 50 seconds or longer.

8: A method for producing the high-strength plated steel sheet according to claim 1, the method comprising, in order:
a hot-rolling step of coiling a steel sheet having the steel components of said base steel sheet at a temperature of 500° C. or higher;
a step of keeping the temperature of the steel sheet in temperatures of 500° C. or higher for 60 minutes or longer;
a step of pickling and cold-rolling the steel sheet such that there remain the internal oxidized layer with an average depth d of 4 μm or more;
a step of oxidizing the steel sheet at an air ratio of 0.9 to 1.4 in an oxidizing zone;
a step of soaking the steel sheet in a temperature range not lower than the A_{c3} point in a reducing zone; and
a step of cooling, after the soaking, the steel sheet to any stopping temperature Z satisfying a temperature from 100 to 540° C., and cooling the steel sheet, in a temperature range from 750° C. to a higher temperature of the stopping temperature Z or 500° C., at an average cooling rate of 10° C./second or more, and retaining the steel sheet in said temperature range of 100 to 540° C. for 50 seconds or longer.

9: A method for producing the high-strength plated steel sheet according to claim 3, the method comprising, in order:
a hot-rolling step of coiling a steel sheet having the steel components of said base steel sheet at a temperature of 600° C. or higher;
a step of pickling and cold-rolling the steel sheet such that there remain the internal oxidized layer with an average depth d of 4 μm or more;
a step of oxidizing the steel sheet at an air ratio of 0.9 to 1.4 in an oxidizing zone;
a step of soaking the steel sheet in a temperature range not lower than the A_{c3} point in a reducing zone; and
a step of satisfying, after the soaking, a following requirement (a1):
a requirement (a1) of cooling the steel sheet down to any stopping temperature Zₐ₁ satisfying a temperature from 420 to 500° C. both inclusive, and
cooling the steel sheet at an average cooling rate of 10° C./second or more in a temperature range from 750° C. to 500° C. and
retaining the steel sheet in said temperature range of 420 to 500° C. for 50 seconds or longer.

10: A method for producing the high-strength plated steel sheet according to claim 4, the method comprising, in order:
a hot-rolling step of coiling a steel sheet having the steel components of said base steel sheet at a temperature of 600° C. or higher;
a step of pickling and cold-rolling the steel sheet such that there remain the internal oxidized layer with an average depth d of 4 μm or more;
a step of oxidizing the steel sheet at an air ratio of 0.9 to 1.4 in an oxidizing zone;
a step of soaking the steel sheet in a temperature range not lower than the A_{c3} point in a reducing zone; and
a step of satisfying, after the soaking, any one of following requirements (a2), (b) and (c1):
a requirement (a2) of cooling the steel sheet down to any stopping temperature Zₐ₂ satisfying a temperature not lower than 380° C. and lower than 420° C., and
cooling the steel sheet at an average cooling rate of 10° C./second or more in a temperature range from 750° C. to 500° C. and
retaining the steel sheet in said temperature range not lower than 380° C. and lower than 420° C. for 50 seconds or longer;
a requirement (b) of cooling the steel sheet down to any stopping temperature Z_{b} satisfying an expression (1) described below, and
cooling the steel sheet at an average cooling rate of 10° C./second or more in a temperature range from 750° C. to a higher temperature of the stopping temperature Z_{b} or 500° C.,
retaining the steel sheet in a temperature range T1 satisfying the expression (1) described below for 10 to 100 seconds,
next cooling the steel sheet into a temperature range T2 satisfying the following expression (2) and
retaining the steel sheet in this temperature range T2 for 50 seconds or longer:
400≦T1(° C.)≦540 (1) and
200≦T2(° C.)<400 (2); and
a requirement (c1) of cooling the steel sheet down to any stopping temperature Z_{c1} satisfying an expression (3) described below or the Ms point, and
cooling the steel sheet at an average cooling rate of 10° C./second or more in a temperature range from 750° C. to 500° C.,
retaining the steel sheet in a temperature range T3 satisfying the expression (3) described below for 5 to 180 seconds,
next heating the steel sheet into a temperature range T4 satisfying the following expression (4) and
retaining the steel sheet in this temperature range T4 for 30 seconds or longer:
100≦T3(° C.)<400 (3) and
400≦T4(° C.)≦500 (4).

11: A method for producing the high-strength plated steel sheet according to claim 5, the method comprising, in order:
a hot-rolling step of coiling a steel sheet having the steel components of said base steel sheet at a temperature of 600° C. or higher;
a step of pickling and cold-rolling the steel sheet such that there remain the internal oxidized layer with an average depth d of 4 μm or more;
a step of oxidizing the steel sheet at an air ratio of 0.9 to 1.4 in an oxidizing zone;
a step of soaking the steel sheet in a temperature range not lower than the A_{c3} point in a reducing zone; and
a step of satisfying, after the soaking, a following requirement (a3) or (c2):
a requirement (a3) of cooling the steel sheet down to any stopping temperature Zₐ₃ satisfying a temperature not lower than 150° C. and lower than 380° C., and
cooling the steel sheet at an average cooling rate of 10° C./second or more in a temperature range from 750° C. to 500° C. and
retaining the steel sheet in a temperature range not lower than 150° C. and lower than 380° C. for 50 seconds or longer, and
a requirement (c2) of cooling the steel sheet down to any stopping temperature Z_{c2} satisfying an expression (3) described below, or the Ms point, and
cooling the steel sheet at an average cooling rate of 10° C./second or more in a temperature range from 750° C. to 500° C.,
retaining the steel sheet in a temperature range T3 satisfying the expression (3) described below for 5 to 180 seconds,
next heating the steel sheet into a temperature range T4 satisfying the following expression (4) and
retaining the steel sheet in this temperature range T4 for 30 seconds or longer:
100≦T3(° C.)<400 (3) and
400≦T4(° C.)≦500 (4).

12: A method for producing the high-strength plated steel sheet according to claim 3, the method comprising, in order
a hot-rolling step of coiling a steel sheet having the steel components of said base steel sheet at a temperature of 500° C. or higher;
a step of keeping the temperature of the steel sheet in temperatures of 500° C. or higher for 60 minutes or longer
a step of pickling and cold-rolling the steel sheet such that there remain the internal oxidized layer with an average depth d of 4 μm or more;
a step of oxidizing the steel sheet at an air ratio of 0.9 to 1.4 in an oxidizing zone;
a step of soaking the steel sheet in a temperature range not lower than the A_{c3} point in a reducing zone; and
a step of satisfying, after the soaking, a following requirement (a1):
a requirement (a1) of cooling the steel sheet down to any stopping temperature 41 satisfying a temperature from 420 to 500° C. both inclusive, and
cooling the steel sheet at an average cooling rate of 10° C./second or more in a temperature range from 750° C. to 500° C. and
retaining the steel sheet in said temperature range of 420 to 500° C. for 50 seconds or longer.

13: A method for producing the high-strength plated steel sheet according to claim 4, the method comprising, in order:
a hot-rolling step of coiling a steel sheet having the steel components of said base steel sheet at a temperature of 500° C. or higher;
a step of keeping the temperature of the steel sheet in temperatures of 500° C. or higher for 60 minutes or longer,
a step of pickling and cold-rolling the steel sheet such that there remain the internal oxidized layer with an average depth d of 4 μm or more;
a step of oxidizing the steel sheet at an air ratio of 0.9 to 1.4 in an oxidizing zone;
a step of soaking the steel sheet in a temperature range not lower than the A_{c3} point in a reducing zone; and
a step of satisfying, after the soaking, any one of following requirements (a2), (b) and (c1):
a requirement (a2) of cooling the steel sheet down to any stopping temperature Zₐ₂ satisfying a temperature not lower than 380° C. and lower than 420° C., and
cooling the steel sheet at an average cooling rate of 10° C./second or more in a temperature range from 750° C. to 500° C. and
retaining the steel sheet in said temperature range not lower than 380° C. and lower than 420° C. for 50 seconds or longer;
a requirement (b) of cooling the steel sheet down to any stopping temperature Z_{b} satisfying an expression (1) described below, and
cooling the steel sheet at an average cooling rate of 10° C./second or more in a temperature range from 750° C. to a higher temperature of the stopping temperature Z_{b} or 500° C.,
retaining the steel sheet in a temperature range T1 satisfying the expression (1) described below for 10 to 100 seconds,
next cooling the steel sheet into a temperature range T2 satisfying the following expression (2) and
retaining the steel sheet in this temperature range T2 for 50 seconds or longer:
400≦T1(° C.)≦540 (1) and
200≦T2(° C.)<400 (2); and
a requirement (c1) of cooling the steel sheet down to any stopping temperature Z_{c1} satisfying an expression (3) described below or the Ms point, and
cooling the steel sheet at an average cooling rate of 10° C./second or more in a temperature range from 750° C. to 500° C.,
retaining the steel sheet in a temperature range T3 satisfying the expression (3) described below for 5 to 180 seconds,
next heating the steel sheet into a temperature range T4 satisfying the following expression (4) and
retaining the steel sheet in this temperature range T4 for 30 seconds or longer:
100≦T3(° C.)<400 (3) and
400≦T4(° C.)≦500 (4).

14: A method for producing the high-strength plated steel sheet according to claim 5, the method comprising, in order:
a hot-rolling step of coiling a steel sheet having the steel components of said base steel sheet at a temperature of 500° C. or higher;
a step of keeping the temperature of the steel sheet in temperatures of 500° C. or higher for 60 minutes or longer;
a step of pickling and cold-rolling the steel sheet such that there remain the internal oxidized layer with an average depth d of 4 μm or more;
a step of oxidizing the steel sheet at an air ratio of 0.9 to 1.4 in an oxidizing zone;
a step of soaking the steel sheet in a temperature range not lower than the A_{c3} point in a reducing zone; and
a step of satisfying, after the soaking, a following requirement (a3) or (c2):
a requirement (a3) of cooling the steel sheet down to any stopping temperature Zₐ₃ satisfying a temperature not lower than 150° C. and lower than 380° C., and
cooling the steel sheet at an average cooling rate of 10° C./second or more in a temperature range from 750° C. to 500° C., and
retaining the steel sheet in a temperature range not lower than 150° C. and lower than 380° C. for 50 seconds or longer and
a requirement (c2) of cooling the steel sheet down to any stopping temperature Z_{c2} satisfying an expression (3) described below, or the Ms point, and
cooling the steel sheet at an average cooling rate of 10° C./second or more in a temperature range from 750° C. to 500° C.,
retaining the steel sheet in a temperature range T3 satisfying the expression (3) described below for 5 to 180 seconds,
next heating the steel sheet into a temperature range T4 satisfying the following expression (4) and
retaining the steel sheet in this temperature range T4 for 30 seconds or longer:
100≦T3(° C.)<400 (3) and
400≦T4(° C.)≦500 (4).
